(19) United States
(12) Patent Application Publication
(10) Pub. No.: US 2025/0070944 A1
(43) Pub. Date: Feb. 27, 2025

(54) ACTIVATION OF UNIFIED TRANSMISSION CONFIGURATION INDICATOR STATE

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/721,031

(22) PCT Filed: Feb. 28, 2022
(86) PCT No.: PCT/CN2022/078230

§ 371 Date: Jun. 17, 2024

(51) Int. Cl. H04L 5/00

(52) U.S. Cl. CPC H04L 5/0053; H04L 5/0098

(57) ABSTRACT

Various aspects of the present disclosure generally relate to wireless communication. In some aspects, a user equipment (UE) may receive a first transmission configuration indicator (TCI) activation message that maps a first codepoint and a second code-point to TCI states. The UE may receive a second TCI activation message that maps the first codepoint and the second codepoint to TCI states. The UE may receive, during a TCI activation time for the second TCI activation message, a TCI indication message that indicates a codepoint identifier indication for the first codepoint or the second codepoint. The UE may transmit or receive a communication using a unified TCI state of a codepoint of the second TCI activation message with a lowest identifier, the unified TCI state being applied after an end of the TCI activation time for the second TCI activation message. Numerous other aspects are described.

### FIELD OF THE DISCLOSURE

Aspects of the present disclosure generally relate to wireless communication and to techniques and apparatuses for activating unified transmission configuration indicator states.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first transmission configuration indicator (TCI) activation message that maps a first codepoint to a first unified TCI state and a second codepoint to a second unified TCI state. The method may include receiving a second TCI activation message that maps the first codepoint to a third unified TCI state and the second codepoint to a fourth unified TCI state. The method may include receiving, during a TCI activation time for the second TCI activation message, a TCI indication message that indicates a codepoint identifier indication for the first codepoint or the second codepoint. The method may include transmitting or receiving a communication using a unified TCI state of a codepoint of the second TCI activation message with a lowest identifier, the unified TCI state being applied after an end of the TCI activation time for the second TCI activation message.

Some aspects described herein relate to a method of wireless communication performed by a network entity. The method may include transmitting a first TCI activation message that maps a first codepoint to a first unified TCI state and a second codepoint to a second unified TCI state. The method may include transmitting a second TCI activation message that maps the first codepoint to a third unified TCI state and the second codepoint to a fourth unified TCI state. The method may include transmitting, during a TCI activation time for the second TCI activation message, a TCI indication message that indicates a codepoint identifier indication for the first codepoint or the second codepoint. The method may include transmitting or receiving a communication using a unified TCI state of a codepoint of the second TCI activation message with a lowest identifier, the unified TCI state being applied after an end of the TCI activation time for the second TCI activation message.

Some aspects described herein relate to a method of wireless communication performed by a UE. The method may include receiving a first TCI activation message that maps a first codepoint to a first unified TCI state and a second codepoint to a second unified TCI state. The method may include receiving a second TCI activation message that maps the first codepoint to a third unified TCI state and the second codepoint to a fourth unified TCI state. The method may include receiving, during a TCI activation time for the second TCI activation message, a TCI indication message that indicates a codepoint identifier indication. The method may include transmitting or receiving a communication using a unified TCI state that corresponds to a codepoint of the first TCI activation message that matches the codepoint identifier indication, the unified TCI state being applied after an end of the TCI activation time for the second TCI activation message.

Some aspects described herein relate to a method of wireless communication performed by a network entity. The method may include transmitting a first TCI activation message that maps a first codepoint to a first unified TCI state and a second codepoint to a second unified TCI state. The method may include transmitting a second TCI activation message that maps the first codepoint to a third unified TCI state and the second codepoint to a fourth unified TCI state. The method may include transmitting, during a TCI activation time for the second TCI activation message, a TCI indication message that indicates a codepoint identifier indication. The method may include transmitting or receiving a communication using a unified TCI state that corresponds to a codepoint of the first TCI activation message that matches the codepoint identifier indication, the unified TCI state being applied after an end of the TCI activation time for the second TCI activation message.

Some aspects described herein relate to a method of wireless communication performed by a UE. The method may include receiving a first TCI activation message that maps a first codepoint to a first unified TCI state and a second codepoint to a second unified TCI state. The method may include receiving a second TCI activation message that maps the first codepoint to a third unified TCI state and the second codepoint to a fourth unified TCI state. The method may include receiving, during a TCI activation time for the second TCI activation message, a TCI indication message that indicates a codepoint identifier indication. The method may include transmitting or receiving a communication using a unified TCI state that corresponds to a codepoint of the second TCI activation message that matches the codepoint identifier indication, the unified TCI state being applied after an end of the TCI activation time for the second TCI activation message.

Some aspects described herein relate to a method of wireless communication performed by a network entity. The method may include transmitting a first TCI activation message that maps a first codepoint to a first unified TCI state and a second codepoint to a second unified TCI state. The method may include transmitting a second TCI activation message that maps the first codepoint to a third unified TCI state and the second codepoint to a fourth unified TCI state. The method may include transmitting, during a TCI activation time for the second TCI activation message, a TCI indication message that indicates a codepoint identifier indication. The method may include transmitting or receiving a communication using a unified TCI state that corresponds to a codepoint of the second TCI activation message that matches the codepoint identifier indication, the unified TCI state being applied after an end of the TCI activation time for the second TCI activation message.

Some aspects described herein relate to a method of wireless communication performed by a UE. The method may include receiving a first TCI activation message that maps a first codepoint to a first unified TCI state and a second codepoint to a second unified TCI state. The method may include receiving a second TCI activation message that maps the first codepoint to a third unified TCI state and the second codepoint to a fourth unified TCI state. The method may include receiving a first TCI indication message that indicates a first codepoint identifier indication. The method may include refraining from applying any unified TCI states indicated after the second TCI activation message and before an end of a TCI application time for the first TCI indication message. The method may include transmitting or receiving a communication using a unified TCI state of whichever of the first TCI activation message or the second TCI activation message has a codepoint that matches the first codepoint identifier indication.

Some aspects described herein relate to a method of wireless communication performed by a network entity. The method may include transmitting a first TCI activation message that maps a first codepoint to a first unified TCI state and a second codepoint to a second unified TCI state. The method may include transmitting a second TCI activation message that maps the first codepoint to a third unified TCI state and the second codepoint to a fourth unified TCI state. The method may include transmitting a TCI indication message that indicates a codepoint identifier indication. The method may include refraining from applying any unified TCI states indicated after the second TCI activation message and before an end of a TCI application time for the TCI indication message. The method may include transmitting or receiving a communication using a unified TCI state of whichever of the first TCI activation message or the second TCI activation message has a codepoint that matches the codepoint identifier indication.

Some aspects described herein relate to a method of wireless communication performed by a UE. The method may include receiving a first TCI activation message that maps a first codepoint to a first unified TCI state and a second codepoint to a second unified TCI state. The method may include receiving a second TCI activation message that maps the first codepoint to a third unified TCI state and the second codepoint to a fourth unified TCI state. The method may include receiving, during a TCI activation time for the second TCI activation message, a first TCI indication message that indicates a first codepoint identifier indication. The method may include refraining from applying a matching unified TCI state of a matching codepoint of the second TCI activation message that matches the first codepoint identifier indication until after receiving a second TCI indication message that indicates a second codepoint identifier indication that is different than the first codepoint identifier indication. The method may include transmitting or receiving a communication using the matching unified TCI state, the matching unified TCI state being applied after receiving the second TCI indication message.

Some aspects described herein relate to a method of wireless communication performed by a network entity. The method may include transmitting a first TCI activation message that maps a first codepoint to a first unified TCI state and a second codepoint to a second unified TCI state. The method may include transmitting a second TCI activation message that maps the first codepoint to a third unified TCI state and the second codepoint to a fourth unified TCI state. The method may include transmitting, during a TCI activation time for the second TCI activation message, a first TCI indication message that indicates a first codepoint identifier indication. The method may include refraining from applying a matching unified TCI state of a matching codepoint of the second TCI activation message that matches the first codepoint identifier indication until after transmitting a second TCI indication message that indicates a second codepoint identifier indication that is different than the first codepoint identifier indication. The method may include transmitting or receiving a communication using the matching unified TCI state, the matching unified TCI state being applied after transmitting the second TCI indication message.

Some aspects described herein relate to a UE for wireless communication. The UE may include a memory and one or more processors coupled to the memory. The one or more processors may be configured to receive a first TCI activation message that maps a first codepoint to a first unified TCI state and a second codepoint to a second unified TCI state. The one or more processors may be configured to receive a second TCI activation message that maps the first codepoint to a third unified TCI state and the second codepoint to a fourth unified TCI state. The one or more processors may be configured to receive, during a TCI activation time for the second TCI activation message, a TCI indication message that indicates a codepoint identifier indication for the first codepoint or the second codepoint. The one or more processors may be configured to transmit or receive a communication using a unified TCI state of a codepoint of the second TCI activation message with a lowest identifier, the unified TCI state being applied after an end of the TCI activation time for the second TCI activation message.

Some aspects described herein relate to a network entity for wireless communication. The network entity may include a memory and one or more processors coupled to the memory. The one or more processors may be configured to transmit a first TCI activation message that maps a first codepoint to a first unified TCI state and a second codepoint to a second unified TCI state. The one or more processors may be configured to transmit a second TCI activation message that maps the first codepoint to a third unified TCI state and the second codepoint to a fourth unified TCI state. The one or more processors may be configured to transmit, during a TCI activation time for the second TCI activation message, a TCI indication message that indicates a codepoint identifier indication for the first codepoint or the second codepoint. The one or more processors may be configured to transmit or receive a communication using a unified TCI state of a codepoint of the second TCI activation message with a lowest identifier, the unified TCI state being applied after an end of the TCI activation time for the second TCI activation message.

Some aspects described herein relate to a UE for wireless communication. The UE may include a memory and one or more processors coupled to the memory. The one or more processors may be configured to receive a first TCI activation message that maps a first codepoint to a first unified TCI state and a second codepoint to a second unified TCI state. The one or more processors may be configured to receive a second TCI activation message that maps the first codepoint to a third unified TCI state and the second codepoint to a fourth unified TCI state. The one or more processors may be configured to receive, during a TCI activation time for the second TCI activation message, a TCI indication message that indicates a codepoint identifier indication. The one or more processors may be configured to transmit or receive a communication using a unified TCI state that corresponds to a codepoint of the first TCI activation message that matches the codepoint identifier indication, the unified TCI state being applied after an end of the TCI activation time for the second TCI activation message.

Some aspects described herein relate to a network entity for wireless communication. The network entity may include a memory and one or more processors coupled to the memory. The one or more processors may be configured to transmit a first TCI activation message that maps a first codepoint to a first unified TCI state and a second codepoint to a second unified TCI state. The one or more processors may be configured to transmit a second TCI activation message that maps the first codepoint to a third unified TCI state and the second codepoint to a fourth unified TCI state. The one or more processors may be configured to transmit, during a TCI activation time for the second TCI activation message, a TCI indication message that indicates a codepoint identifier indication. The one or more processors may be configured to transmit or receive a communication using a unified TCI state that corresponds to a codepoint of the first TCI activation message that matches the codepoint identifier indication, the unified TCI state being applied after an end of the TCI activation time for the second TCI activation message.

Some aspects described herein relate to a UE for wireless communication. The UE may include a memory and one or more processors coupled to the memory. The one or more processors may be configured to receive a first TCI activation message that maps a first codepoint to a first unified TCI state and a second codepoint to a second unified TCI state. The one or more processors may be configured to receive a second TCI activation message that maps the first codepoint to a third unified TCI state and the second codepoint to a fourth unified TCI state. The one or more processors may be configured to receive, during a TCI activation time for the second TCI activation message, a TCI indication message that indicates a codepoint identifier indication. The one or more processors may be configured to transmit or receive a communication using a unified TCI state that corresponds to a codepoint of the second TCI activation message that matches the codepoint identifier indication, the unified TCI state being applied after an end of the TCI activation time for the second TCI activation message.

Some aspects described herein relate to a network entity for wireless communication. The network entity may include a memory and one or more processors coupled to the memory. The one or more processors may be configured to transmit a first TCI activation message that maps a first codepoint to a first unified TCI state and a second codepoint to a second unified TCI state. The one or more processors may be configured to transmit a second TCI activation message that maps the first codepoint to a third unified TCI state and the second codepoint to a fourth unified TCI state. The one or more processors may be configured to transmit, during a TCI activation time for the second TCI activation message, a TCI indication message that indicates a codepoint identifier indication. The one or more processors may be configured to transmit or receive a communication using a unified TCI state that corresponds to a codepoint of the second TCI activation message that matches the codepoint identifier indication, the unified TCI state being applied after an end of the TCI activation time for the second TCI activation message.

Some aspects described herein relate to a UE for wireless communication. The UE may include a memory and one or more processors coupled to the memory. The one or more processors may be configured to receive a first TCI activation message that maps a first codepoint to a first unified TCI state and a second codepoint to a second unified TCI state. The one or more processors may be configured to receive a second TCI activation message that maps the first codepoint to a third unified TCI state and the second codepoint to a fourth unified TCI state. The one or more processors may be configured to receive a first TCI indication message that indicates a first codepoint identifier indication. The one or more processors may be configured to refrain from applying any unified TCI states indicated after the second TCI activation message and before an end of a TCI application time for the first TCI indication message. The one or more processors may be configured to transmit or receive a communication using a unified TCI state of whichever of the first TCI activation message or the second TCI activation message has a codepoint that matches the first codepoint identifier indication.

Some aspects described herein relate to a network entity for wireless communication. The network entity may include a memory and one or more processors coupled to the memory. The one or more processors may be configured to transmit a first TCI activation message that maps a first codepoint to a first unified TCI state and a second codepoint to a second unified TCI state. The one or more processors may be configured to transmit a second TCI activation message that maps the first codepoint to a third unified TCI state and the second codepoint to a fourth unified TCI state. The one or more processors may be configured to transmit a TCI indication message that indicates a codepoint identifier indication. The one or more processors may be configured to refrain from applying any unified TCI states indicated after the second TCI activation message and before an end of a TCI application time for the TCI indication message. The one or more processors may be configured to transmit or receive a communication using a unified TCI state of whichever of the first TCI activation message or the second TCI activation message has a codepoint that matches the codepoint identifier indication.

Some aspects described herein relate to a UE for wireless communication. The UE may include a memory and one or more processors coupled to the memory. The one or more processors may be configured to receive a first TCI activation message that maps a first codepoint to a first unified TCI state and a second codepoint to a second unified TCI state. The one or more processors may be configured to receive a second TCI activation message that maps the first codepoint to a third unified TCI state and the second codepoint to a fourth unified TCI state. The one or more processors may be configured to receive, during a TCI activation time for the second TCI activation message, a first TCI indication message that indicates a first codepoint identifier indication. The one or more processors may be configured to refrain from applying a matching unified TCI state of a matching codepoint of the second TCI activation message that matches the first codepoint identifier indication until after receiving a second TCI indication message that indicates a second codepoint identifier indication that is different than the first codepoint identifier indication. The one or more processors may be configured to transmit or receive a communication using the matching unified TCI state, the matching unified TCI state being applied after receiving the second TCI indication message.

Some aspects described herein relate to a network entity for wireless communication. The network entity may include a memory and one or more processors coupled to the memory. The one or more processors may be configured to transmit a first TCI activation message that maps a first codepoint to a first unified TCI state and a second codepoint to a second unified TCI state. The one or more processors may be configured to transmit a second TCI activation message that maps the first codepoint to a third unified TCI state and the second codepoint to a fourth unified TCI state. The one or more processors may be configured to transmit, during a TCI activation time for the second TCI activation message, a first TCI indication message that indicates a first codepoint identifier indication. The one or more processors may be configured to refrain from applying a matching unified TCI state of a matching codepoint of the second TCI activation message that matches the first codepoint identifier indication until after transmitting a second TCI indication message that indicates a second codepoint identifier indication that is different than the first codepoint identifier indication. The one or more processors may be configured to transmit or receive a communication using the matching unified TCI state, the matching unified TCI state being applied after transmitting the second TCI indication message.

Some aspects described herein relate to a non-transitory computer-readable medium that stores a set of instructions for wireless communication by a UE. The set of instructions, when executed by one or more processors of the UE, may cause the UE to receive a first TCI activation message that maps a first codepoint to a first unified TCI state and a second codepoint to a second unified TCI state. The set of instructions, when executed by one or more processors of the UE, may cause the UE to receive a second TCI activation message that maps the first codepoint to a third unified TCI state and the second codepoint to a fourth unified TCI state. The set of instructions, when executed by one or more processors of the UE, may cause the UE to receive, during a TCI activation time for the second TCI activation message, a TCI indication message that indicates a codepoint identifier indication for the first codepoint or the second codepoint. The set of instructions, when executed by one or more processors of the UE, may cause the UE to transmit or receive a communication using a unified TCI state of a codepoint of the second TCI activation message with a lowest identifier, the unified TCI state being applied after an end of the TCI activation time for the second TCI activation message.

Some aspects described herein relate to a non-transitory computer-readable medium that stores a set of instructions for wireless communication by a network entity. The set of instructions, when executed by one or more processors of the network entity, may cause the network entity to transmit a first TCI activation message that maps a first codepoint to a first unified TCI state and a second codepoint to a second unified TCI state. The set of instructions, when executed by one or more processors of the network entity, may cause the network entity to transmit a second TCI activation message that maps the first codepoint to a third unified TCI state and the second codepoint to a fourth unified TCI state. The set of instructions, when executed by one or more processors of the network entity, may cause the network entity to transmit, during a TCI activation time for the second TCI activation message, a TCI indication message that indicates a codepoint identifier indication for the first codepoint or the second codepoint. The set of instructions, when executed by one or more processors of the network entity, may cause the network entity to transmit or receive a communication using a unified TCI state of a codepoint of the second TCI activation message with a lowest identifier, the unified TCI state being applied after an end of the TCI activation time for the second TCI activation message.

Some aspects described herein relate to a non-transitory computer-readable medium that stores a set of instructions for wireless communication by a UE. The set of instructions, when executed by one or more processors of the UE, may cause the UE to receive a first TCI activation message that maps a first codepoint to a first unified TCI state and a second codepoint to a second unified TCI state. The set of instructions, when executed by one or more processors of the UE, may cause the UE to receive a second TCI activation message that maps the first codepoint to a third unified TCI state and the second codepoint to a fourth unified TCI state. The set of instructions, when executed by one or more processors of the UE, may cause the UE to receive, during a TCI activation time for the second TCI activation message, a TCI indication message that indicates a codepoint identifier indication. The set of instructions, when executed by one or more processors of the UE, may cause the UE to transmit or receive a communication using a unified TCI state that corresponds to a codepoint of the first TCI activation message that matches the codepoint identifier indication, the unified TCI state being applied after an end of the TCI activation time for the second TCI activation message.

Some aspects described herein relate to a non-transitory computer-readable medium that stores a set of instructions for wireless communication by a network entity. The set of instructions, when executed by one or more processors of the network entity, may cause the network entity to transmit a first TCI activation message that maps a first codepoint to a first unified TCI state and a second codepoint to a second unified TCI state. The set of instructions, when executed by one or more processors of the network entity, may cause the network entity to transmit a second TCI activation message that maps the first codepoint to a third unified TCI state and the second codepoint to a fourth unified TCI state. The set of instructions, when executed by one or more processors of the network entity, may cause the network entity to transmit, during a TCI activation time for the second TCI activation message, a TCI indication message that indicates a codepoint identifier indication. The set of instructions, when executed by one or more processors of the network entity, may cause the network entity to transmit or receive a communication using a unified TCI state that corresponds to a codepoint of the first TCI activation message that matches the codepoint identifier indication, the unified TCI state being applied after an end of the TCI activation time for the second TCI activation message.

Some aspects described herein relate to a non-transitory computer-readable medium that stores a set of instructions for wireless communication by a UE. The set of instructions, when executed by one or more processors of the UE, may cause the UE to receive a first TCI activation message that maps a first codepoint to a first unified TCI state and a second codepoint to a second unified TCI state. The set of instructions, when executed by one or more processors of the UE, may cause the UE to receive a second TCI activation message that maps the first codepoint to a third unified TCI state and the second codepoint to a fourth unified TCI state. The set of instructions, when executed by one or more processors of the UE, may cause the UE to receive, during a TCI activation time for the second TCI activation message, a TCI indication message that indicates a codepoint identifier indication. The set of instructions, when executed by one or more processors of the UE, may cause the UE to transmit or receive a communication using a unified TCI state that corresponds to a codepoint of the second TCI activation message that matches the codepoint identifier indication, the unified TCI state being applied after an end of the TCI activation time for the second TCI activation message.

Some aspects described herein relate to a non-transitory computer-readable medium that stores a set of instructions for wireless communication by a network entity. The set of instructions, when executed by one or more processors of the network entity, may cause the network entity to transmit a first TCI activation message that maps a first codepoint to a first unified TCI state and a second codepoint to a second unified TCI state. The set of instructions, when executed by one or more processors of the network entity, may cause the network entity to transmit a second TCI activation message that maps the first codepoint to a third unified TCI state and the second codepoint to a fourth unified TCI state. The set of instructions, when executed by one or more processors of the network entity, may cause the network entity to transmit, during a TCI activation time for the second TCI activation message, a TCI indication message that indicates a codepoint identifier indication. The set of instructions, when executed by one or more processors of the network entity, may cause the network entity to transmit or receive a communication using a unified TCI state that corresponds to a codepoint of the second TCI activation message that matches the codepoint identifier indication, the unified TCI state being applied after an end of the TCI activation time for the second TCI activation message.

Some aspects described herein relate to a non-transitory computer-readable medium that stores a set of instructions for wireless communication by a UE. The set of instructions, when executed by one or more processors of the UE, may cause the UE to receive a first TCI activation message that maps a first codepoint to a first unified TCI state and a second codepoint to a second unified TCI state. The set of instructions, when executed by one or more processors of the UE, may cause the UE to receive a second TCI activation message that maps the first codepoint to a third unified TCI state and the second codepoint to a fourth unified TCI state. The set of instructions, when executed by one or more processors of the UE, may cause the UE to receive a first TCI indication message that indicates a first codepoint identifier indication. The set of instructions, when executed by one or more processors of the UE, may cause the UE to refrain from applying any unified TCI states indicated after the second TCI activation message and before an end of a TCI application time for the first TCI indication message. The set of instructions, when executed by one or more processors of the UE, may cause the UE to transmit or receive a communication using a unified TCI state of whichever of the first TCI activation message or the second TCI activation message has a codepoint that matches the first codepoint identifier indication.

Some aspects described herein relate to a non-transitory computer-readable medium that stores a set of instructions for wireless communication by a network entity. The set of instructions, when executed by one or more processors of the network entity, may cause the network entity to transmit a first TCI activation message that maps a first codepoint to a first unified TCI state and a second codepoint to a second unified TCI state. The set of instructions, when executed by one or more processors of the network entity, may cause the network entity to transmit a second TCI activation message that maps the first codepoint to a third unified TCI state and the second codepoint to a fourth unified TCI state. The set of instructions, when executed by one or more processors of the network entity, may cause the network entity to transmit a TCI indication message that indicates a codepoint identifier indication. The set of instructions, when executed by one or more processors of the network entity, may cause the network entity to refrain from applying any unified TCI states indicated after the second TCI activation message and before an end of a TCI application time for the TCI indication message. The set of instructions, when executed by one or more processors of the network entity, may cause the network entity to transmit or receive a communication using a unified TCI state of whichever of the first TCI activation message or the second TCI activation message has a codepoint that matches the codepoint identifier indication.

Some aspects described herein relate to a non-transitory computer-readable medium that stores a set of instructions for wireless communication by a UE. The set of instructions, when executed by one or more processors of the UE, may cause the UE to receive a first TCI activation message that maps a first codepoint to a first unified TCI state and a second codepoint to a second unified TCI state. The set of instructions, when executed by one or more processors of the UE, may cause the UE to receive a second TCI activation message that maps the first codepoint to a third unified TCI state and the second codepoint to a fourth unified TCI state. The set of instructions, when executed by one or more processors of the UE, may cause the UE to receive, during a TCI activation time for the second TCI activation message, a first TCI indication message that indicates a first codepoint identifier indication. The set of instructions, when executed by one or more processors of the UE, may cause the UE to refrain from applying a matching unified TCI state of a matching codepoint of the second TCI activation message that matches the first codepoint identifier indication until after receiving a second TCI indication message that indicates a second codepoint identifier indication that is different than the first codepoint identifier indication. The set of instructions, when executed by one or more processors of the UE, may cause the UE to transmit or receive a communication using the matching unified TCI state, the matching unified TCI state being applied after receiving the second TCI indication message.

Some aspects described herein relate to a non-transitory computer-readable medium that stores a set of instructions for wireless communication by a network entity. The set of instructions, when executed by one or more processors of the network entity, may cause the network entity to transmit a first TCI activation message that maps a first codepoint to a first unified TCI state and a second codepoint to a second unified TCI state. The set of instructions, when executed by one or more processors of the network entity, may cause the network entity to transmit a second TCI activation message that maps the first codepoint to a third unified TCI state and the second codepoint to a fourth unified TCI state. The set of instructions, when executed by one or more processors of the network entity, may cause the network entity to transmit, during a TCI activation time for the second TCI activation message, a first TCI indication message that indicates a first codepoint identifier indication. The set of instructions, when executed by one or more processors of the network entity, may cause the network entity to refrain from applying a matching unified TCI state of a matching codepoint of the second TCI activation message that matches the first codepoint identifier indication until after transmitting a second TCI indication message that indicates a second codepoint identifier indication that is different than the first codepoint identifier indication. The set of instructions, when executed by one or more processors of the network entity, may cause the network entity to transmit or receive a communication using the matching unified TCI state, the matching unified TCI state being applied after transmitting the second TCI indication message.

Some aspects described herein relate to an apparatus for wireless communication. The apparatus may include means for receiving a first TCI activation message that maps a first codepoint to a first unified TCI state and a second codepoint to a second unified TCI state. The apparatus may include means for receiving a second TCI activation message that maps the first codepoint to a third unified TCI state and the second codepoint to a fourth unified TCI state. The apparatus may include means for receiving, during a TCI activation time for the second TCI activation message, a TCI indication message that indicates a codepoint identifier indication for the first codepoint or the second codepoint. The apparatus may include means for transmitting or receiving a communication using a unified TCI state of a codepoint of the second TCI activation message with a lowest identifier, the unified TCI state being applied after an end of the TCI activation time for the second TCI activation message.

Some aspects described herein relate to an apparatus for wireless communication. The apparatus may include means for transmitting a first TCI activation message that maps a first codepoint to a first unified TCI state and a second codepoint to a second unified TCI state. The apparatus may include means for transmitting a second TCI activation message that maps the first codepoint to a third unified TCI state and the second codepoint to a fourth unified TCI state. The apparatus may include means for transmitting, during a TCI activation time for the second TCI activation message, a TCI indication message that indicates a codepoint identifier indication for the first codepoint or the second codepoint. The apparatus may include means for transmitting or receiving a communication using a unified TCI state of a codepoint of the second TCI activation message with a lowest identifier, the unified TCI state being applied after an end of the TCI activation time for the second TCI activation message.

Some aspects described herein relate to an apparatus for wireless communication. The apparatus may include means for receiving a first TCI activation message that maps a first codepoint to a first unified TCI state and a second codepoint to a second unified TCI state. The apparatus may include means for receiving a second TCI activation message that maps the first codepoint to a third unified TCI state and the second codepoint to a fourth unified TCI state. The apparatus may include means for receiving, during a TCI activation time for the second TCI activation message, a TCI indication message that indicates a codepoint identifier indication. The apparatus may include means for transmitting or receiving a communication using a unified TCI state that corresponds to a codepoint of the first TCI activation message that matches the codepoint identifier indication, the unified TCI state being applied after an end of the TCI activation time for the second TCI activation message.

Some aspects described herein relate to an apparatus for wireless communication. The apparatus may include means for transmitting a first TCI activation message that maps a first codepoint to a first unified TCI state and a second codepoint to a second unified TCI state. The apparatus may include means for transmitting a second TCI activation message that maps the first codepoint to a third unified TCI state and the second codepoint to a fourth unified TCI state. The apparatus may include means for transmitting, during a TCI activation time for the second TCI activation message, a TCI indication message that indicates a codepoint identifier indication. The apparatus may include means for transmitting or receiving a communication using a unified TCI state that corresponds to a codepoint of the first TCI activation message that matches the codepoint identifier indication, the unified TCI state being applied after an end of the TCI activation time for the second TCI activation message.

Some aspects described herein relate to an apparatus for wireless communication. The apparatus may include means for receiving a first TCI activation message that maps a first codepoint to a first unified TCI state and a second codepoint to a second unified TCI state. The apparatus may include means for receiving a second TCI activation message that maps the first codepoint to a third unified TCI state and the second codepoint to a fourth unified TCI state. The apparatus may include means for receiving, during a TCI activation time for the second TCI activation message, a TCI indication message that indicates a codepoint identifier indication. The apparatus may include means for transmitting or receiving a communication using a unified TCI state that corresponds to a codepoint of the second TCI activation message that matches the codepoint identifier indication, the unified TCI state being applied after an end of the TCI activation time for the second TCI activation message.

Some aspects described herein relate to an apparatus for wireless communication. The apparatus may include means for transmitting a first TCI activation message that maps a first codepoint to a first unified TCI state and a second codepoint to a second unified TCI state. The apparatus may include means for transmitting a second TCI activation message that maps the first codepoint to a third unified TCI state and the second codepoint to a fourth unified TCI state. The apparatus may include means for transmitting, during a TCI activation time for the second TCI activation message, a TCI indication message that indicates a codepoint identifier indication. The apparatus may include means for transmitting or receiving a communication using a unified TCI state that corresponds to a codepoint of the second TCI activation message that matches the codepoint identifier indication, the unified TCI state being applied after an end of the TCI activation time for the second TCI activation message.

Some aspects described herein relate to an apparatus for wireless communication. The apparatus may include means for receiving a first TCI activation message that maps a first codepoint to a first unified TCI state and a second codepoint to a second unified TCI state. The apparatus may include means for receiving a second TCI activation message that maps the first codepoint to a third unified TCI state and the second codepoint to a fourth unified TCI state. The apparatus may include means for receiving a first TCI indication message that indicates a first codepoint identifier indication. The apparatus may include means for refraining from applying any unified TCI states indicated after the second TCI activation message and before an end of a TCI application time for the first TCI indication message. The apparatus may include means for transmitting or receiving a communication using a unified TCI state of whichever of the first TCI activation message or the second TCI activation message has a codepoint that matches the first codepoint identifier indication.

Some aspects described herein relate to an apparatus for wireless communication. The apparatus may include means for transmitting a first TCI activation message that maps a first codepoint to a first unified TCI state and a second codepoint to a second unified TCI state. The apparatus may include means for transmitting a second TCI activation message that maps the first codepoint to a third unified TCI state and the second codepoint to a fourth unified TCI state. The apparatus may include means for transmitting a TCI indication message that indicates a codepoint identifier indication. The apparatus may include means for refraining from applying any unified TCI states indicated after the second TCI activation message and before an end of a TCI application time for the TCI indication message. The apparatus may include means for transmitting or receiving a communication using a unified TCI state of whichever of the first TCI activation message or the second TCI activation message has a codepoint that matches the codepoint identifier indication.

Some aspects described herein relate to an apparatus for wireless communication. The apparatus may include means for receiving a first TCI activation message that maps a first codepoint to a first unified TCI state and a second codepoint to a second unified TCI state. The apparatus may include means for receiving a second TCI activation message that maps the first codepoint to a third unified TCI state and the second codepoint to a fourth unified TCI state. The apparatus may include means for receiving, during a TCI activation time for the second TCI activation message, a first TCI indication message that indicates a first codepoint identifier indication. The apparatus may include means for refraining from applying a matching unified TCI state of a matching codepoint of the second TCI activation message that matches the first codepoint identifier indication until after receiving a second TCI indication message that indicates a second codepoint identifier indication that is different than the first codepoint identifier indication. The apparatus may include means for transmitting or receiving a communication using the matching unified TCI state, the matching unified TCI state being applied after receiving the second TCI indication message.

Some aspects described herein relate to an apparatus for wireless communication. The apparatus may include means for transmitting a first TCI activation message that maps a first codepoint to a first unified TCI state and a second codepoint to a second unified TCI state. The apparatus may include means for transmitting a second TCI activation message that maps the first codepoint to a third unified TCI state and the second codepoint to a fourth unified TCI state. The apparatus may include means for transmitting, during a TCI activation time for the second TCI activation message, a first TCI indication message that indicates a first codepoint identifier indication. The apparatus may include means for refraining from applying a matching unified TCI state of a matching codepoint of the second TCI activation message that matches the first codepoint identifier indication until after transmitting a second TCI indication message that indicates a second codepoint identifier indication that is different than the first codepoint identifier indication. The apparatus may include means for transmitting or receiving a communication using the matching unified TCI state, the matching unified TCI state being applied after transmitting the second TCI indication message.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of using beams for communications between a base station and a UE, in accordance with the present disclosure.

FIG. 5 is a diagram illustrating an example of transmission configuration indicator (TCI) activation and application times, in accordance with the present disclosure.

FIGS. 6-10 are diagrams illustrating examples of TCI state activation, in accordance with the present disclosure.

FIGS. 11-20 are diagrams illustrating processes performed by a UE or a network entity, in accordance with the present disclosure.

FIGS. 21-22 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

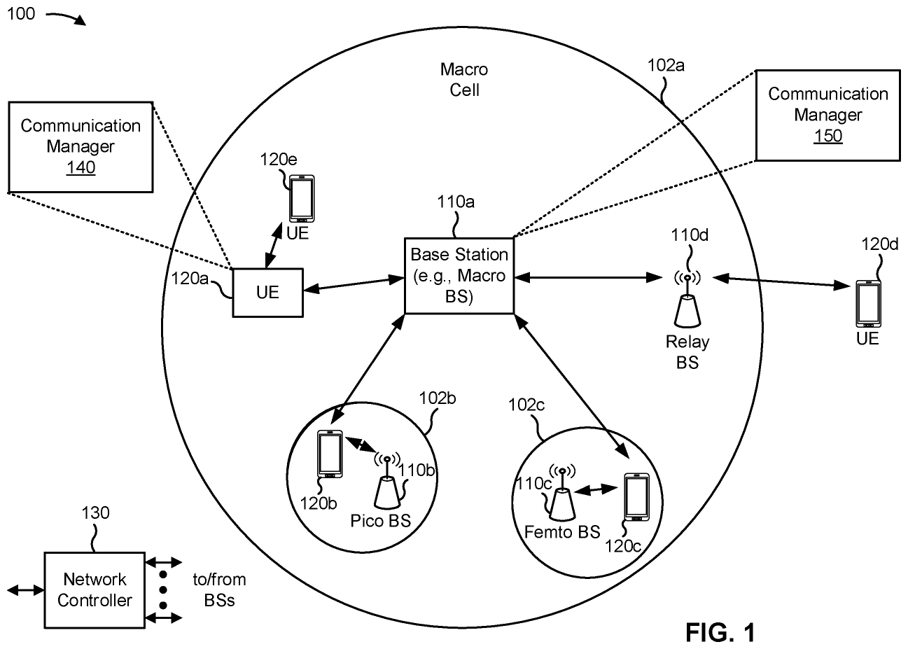

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first transmission configuration indicator (TCI) activation message that maps a first codepoint to a first unified TCI state and a second codepoint to a second unified TCI state; receive a second TCI activation message that maps the first codepoint to a third unified TCI state and the second codepoint to a fourth unified TCI state; receive, during a TCI activation time for the second TCI activation message, a TCI indication message that indicates a codepoint identifier indication for the first codepoint or the second codepoint; and transmit or receive a communication using a unified TCI state of a codepoint of the second TCI activation message with a lowest identifier, the unified TCI state being applied after an end of the TCI activation time for the second TCI activation message.

In some aspects, the network entity may include a communication manager 150. As described in more detail elsewhere herein, the communication manager 150 may transmit a first TCI activation message that maps a first codepoint to a first unified TCI state and a second codepoint to a second unified TCI state; transmit a second TCI activation message that maps the first codepoint to a third unified TCI state and the second codepoint to a fourth unified TCI state; transmit, during a TCI activation time for the second TCI activation message, a TCI indication message that indicates a codepoint identifier indication for the first codepoint or the second codepoint; and transmit or receive a communication using a unified TCI state of a codepoint of the second TCI activation message with a lowest identifier, the unified TCI state being applied after an end of the TCI activation time for the second TCI activation message.

In some aspects, the communication manager 140 may receive a first TCI activation message that maps a first codepoint to a first unified TCI state and a second codepoint to a second unified TCI state; receive a second TCI activation message that maps the first codepoint to a third unified TCI state and the second codepoint to a fourth unified TCI state; receive, during a TCI activation time for the second TCI activation message, a TCI indication message that indicates a codepoint identifier indication; and transmit or receive a communication using a unified TCI state that corresponds to a codepoint of the first TCI activation message that matches the codepoint identifier indication, the unified TCI state being applied after an end of the TCI activation time for the second TCI activation message.

In some aspects, the communication manager 150 may transmit a first TCI activation message that maps a first codepoint to a first unified TCI state and a second codepoint to a second unified TCI state; transmit a second TCI activation message that maps the first codepoint to a third unified TCI state and the second codepoint to a fourth unified TCI state; transmit, during a TCI activation time for the second TCI activation message, a TCI indication message that indicates a codepoint identifier indication; and transmit or receive a communication using a unified TCI state that corresponds to a codepoint of the first TCI activation message that matches the codepoint identifier indication, the unified TCI state being applied after an end of the TCI activation time for the second TCI activation message.

In some aspects, the communication manager 140 may receive a first TCI activation message that maps a first codepoint to a first unified TCI state and a second codepoint to a second unified TCI state; receive a second TCI activation message that maps the first codepoint to a third unified TCI state and the second codepoint to a fourth unified TCI state; receive, during a TCI activation time for the second TCI activation message, a TCI indication message that indicates a codepoint identifier indication; and transmit or receive a communication using a unified TCI state that corresponds to a codepoint of the second TCI activation message that matches the codepoint identifier indication, the unified TCI state being applied after an end of the TCI activation time for the second TCI activation message.

In some aspects, the communication manager 150 may transmit a first TCI activation message that maps a first codepoint to a first unified TCI state and a second codepoint to a second unified TCI state; transmit a second TCI activation message that maps the first codepoint to a third unified TCI state and the second codepoint to a fourth unified TCI state; transmit, during a TCI activation time for the second TCI activation message, a TCI indication message that indicates a codepoint identifier indication; and transmit or receive a communication using a unified TCI state that corresponds to a codepoint of the second TCI activation message that matches the codepoint identifier indication, the unified TCI state being applied after an end of the TCI activation time for the second TCI activation message.

In some aspects, the communication manager 140 may receive a first TCI activation message that maps a first codepoint to a first unified TCI state and a second codepoint to a second unified TCI state; receive a second TCI activation message that maps the first codepoint to a third unified TCI state and the second codepoint to a fourth unified TCI state; receive a first TCI indication message that indicates a first codepoint identifier indication; refrain from applying any unified TCI states indicated after the second TCI activation message and before an end of a TCI application time for the first TCI indication message; and transmit or receive a communication using a unified TCI state of whichever of the first TCI activation message or the second TCI activation message has a codepoint that matches the first codepoint identifier indication.

In some aspects, the communication manager 150 may transmit a first TCI activation message that maps a first codepoint to a first unified TCI state and a second codepoint to a second unified TCI state; transmit a second TCI activation message that maps the first codepoint to a third unified TCI state and the second codepoint to a fourth unified TCI state; transmit a TCI indication message that indicates a codepoint identifier indication; refrain from applying any unified TCI states indicated after the second TCI activation message and before an end of a TCI application time for the TCI indication message; and transmit or receive a communication using a unified TCI state of whichever of the first TCI activation message or the second TCI activation message has a codepoint that matches the codepoint identifier indication.

In some aspects, the communication manager 140 may receive a first TCI activation message that maps a first codepoint to a first unified TCI state and a second codepoint to a second unified TCI state; receive a second TCI activation message that maps the first codepoint to a third unified TCI state and the second codepoint to a fourth unified TCI state; receive, during a TCI activation time for the second TCI activation message, a first TCI indication message that indicates a first codepoint identifier indication; refrain from applying a matching unified TCI state of a matching codepoint of the second TCI activation message that matches the first codepoint identifier indication until after receiving a second TCI indication message that indicates a second codepoint identifier indication that is different than the first codepoint identifier indication; and transmit or receive a communication using the matching unified TCI state, the matching unified TCI state being applied after receiving the second TCI indication message. Additionally, or alternatively, the communication manager 140 may perform one or more other operations described herein.

In some aspects, the communication manager 150 may transmit a first TCI activation message that maps a first codepoint to a first unified TCI state and a second codepoint to a second unified TCI state; transmit a second TCI activation message that maps the first codepoint to a third unified TCI state and the second codepoint to a fourth unified TCI state; transmit, during a TCI activation time for the second TCI activation message, a first TCI indication message that indicates a first codepoint identifier indication; refrain from applying a matching unified TCI state of a matching codepoint of the second TCI activation message that matches the first codepoint identifier indication until after transmitting a second TCI indication message that indicates a second codepoint identifier indication that is different than the first codepoint identifier indication; and transmit or receive a communication using the matching unified TCI state, the matching unified TCI state being applied after transmitting the second TCI indication message. Additionally, or alternatively, the communication manager 150 may perform one or more other operations described herein.

As indicated above, FIG. 1 is provided as an example. Other examples may differ from what is described with regard to FIG. 1.

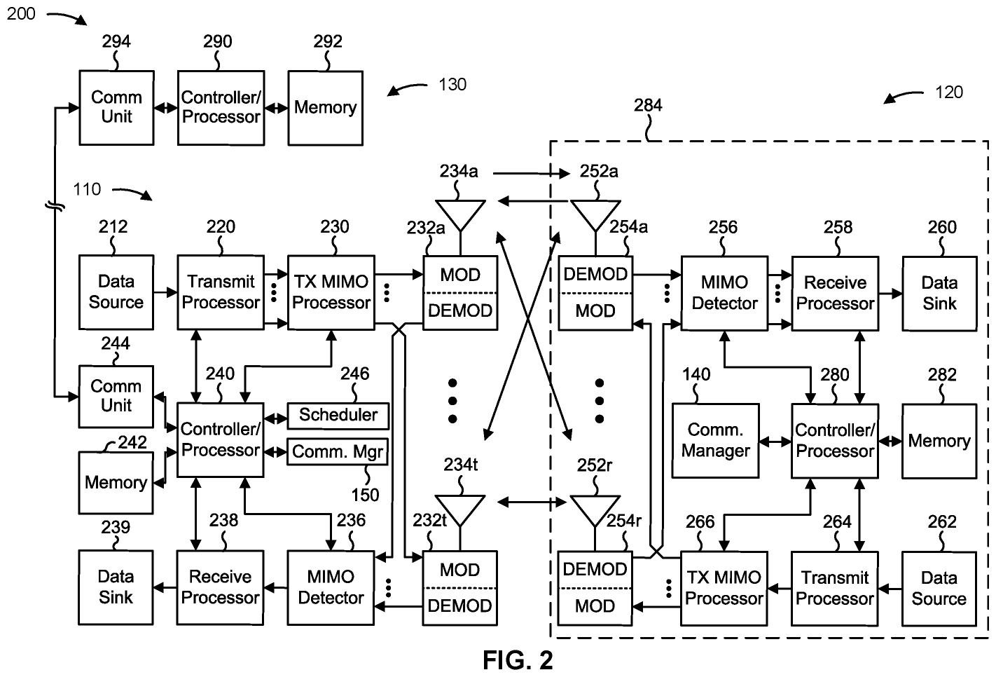

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

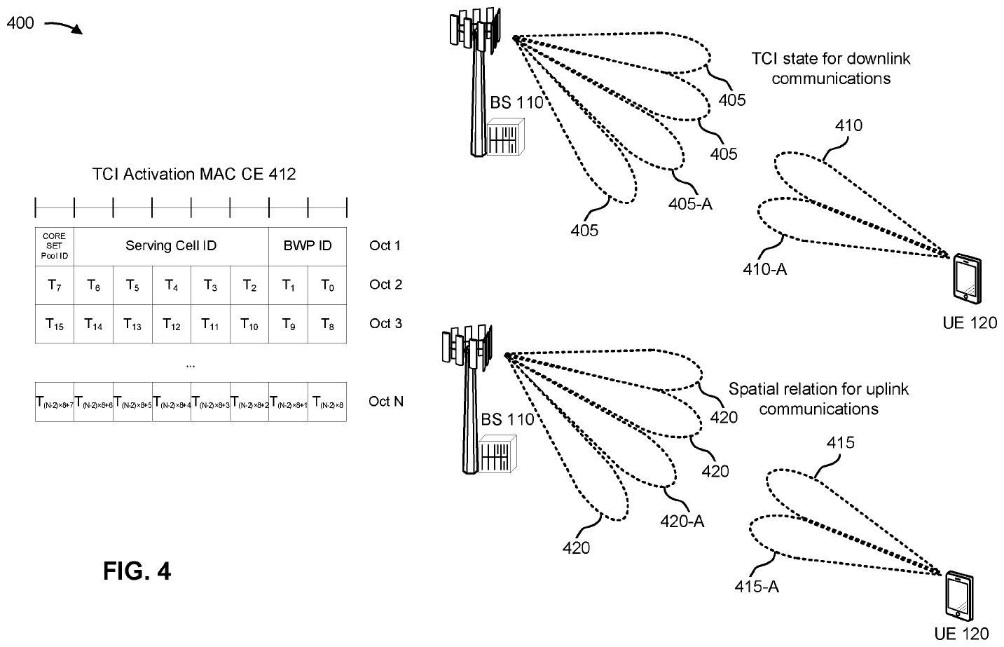

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-22).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-22).

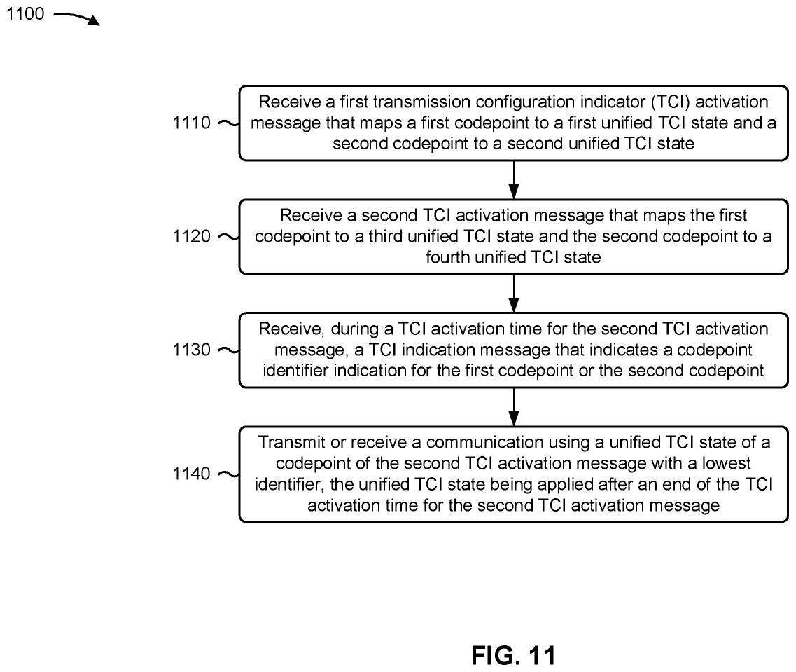

A controller/processor of a network entity, (e.g., the controller/processor 240 of the base station 110), the controller/processor 280 of the UE 120, and/or any other component(s) of FIG. 2 may perform one or more techniques associated with activating TCI states, as described in more detail elsewhere herein. In some aspects, the [mobile station] described herein is the UE 120, is included in the UE 120, or includes one or more components of the UE 120 shown in FIG. 2. In some aspects, the [TRP/node/IAB node/etc.] described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, processes 1100-2000 in FIGS. 11-20, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, processes 1100-2000 in FIGS. 11-20, and/or other processes as described herein. In some examples, executing instructions may include running the instructions, converting the instructions, compiling the instructions, and/or interpreting the instructions, among other examples.

In some aspects, the UE includes means for receiving a first TCI activation message that maps a first codepoint to a first unified TCI state and a second codepoint to a second unified TCI state; means for receiving a second TCI activation message that maps the first codepoint to a third unified TCI state and the second codepoint to a fourth unified TCI state; means for receiving, during a TCI activation time for the second TCI activation message, a TCI indication message that indicates a codepoint identifier indication for the first codepoint or the second codepoint; and/or means for transmitting or receiving a communication using a unified TCI state of a codepoint of the second TCI activation message with a lowest identifier, the unified TCI state being applied after an end of the TCI activation time for the second TCI activation message. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for transmitting a first TCI activation message that maps a first codepoint to a first unified TCI state and a second codepoint to a second unified TCI state; means for transmitting a second TCI activation message that maps the first codepoint to a third unified TCI state and the second codepoint to a fourth unified TCI state; means for transmitting, during a TCI activation time for the second TCI activation message, a TCI indication message that indicates a codepoint identifier indication for the first codepoint or the second codepoint; and/or means for transmitting or receiving a communication using a unified TCI state of a codepoint of the second TCI activation message with a lowest identifier, the unified TCI state being applied after an end of the TCI activation time for the second TCI activation message. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for receiving a first TCI activation message that maps a first codepoint to a first unified TCI state and a second codepoint to a second unified TCI state; means for receiving a second TCI activation message that maps the first codepoint to a third unified TCI state and the second codepoint to a fourth unified TCI state; means for receiving, during a TCI activation time for the second TCI activation message, a TCI indication message that indicates a codepoint identifier indication; and/or means for transmitting or receiving a communication using a unified TCI state that corresponds to a codepoint of the first TCI activation message that matches the codepoint identifier indication, the unified TCI state being applied after an end of the TCI activation time for the second TCI activation message.

In some aspects, the network entity includes means for transmitting a first TCI activation message that maps a first codepoint to a first unified TCI state and a second codepoint to a second unified TCI state; means for transmitting a second TCI activation message that maps the first codepoint to a third unified TCI state and the second codepoint to a fourth unified TCI state; means for transmitting, during a TCI activation time for the second TCI activation message, a TCI indication message that indicates a codepoint identifier indication; and/or means for transmitting or receiving a communication using a unified TCI state that corresponds to a codepoint of the first TCI activation message that matches the codepoint identifier indication, the unified TCI state being applied after an end of the TCI activation time for the second TCI activation message.

In some aspects, the UE includes means for receiving a first TCI activation message that maps a first codepoint to a first unified TCI state and a second codepoint to a second unified TCI state; means for receiving a second TCI activation message that maps the first codepoint to a third unified TCI state and the second codepoint to a fourth unified TCI state; means for receiving, during a TCI activation time for the second TCI activation message, a TCI indication message that indicates a codepoint identifier indication; and/or means for transmitting or receiving a communication using a unified TCI state that corresponds to a codepoint of the second TCI activation message that matches the codepoint identifier indication, the unified TCI state being applied after an end of the TCI activation time for the second TCI activation message.

In some aspects, the network entity includes means for transmitting a first TCI activation message that maps a first codepoint to a first unified TCI state and a second codepoint to a second unified TCI state; means for transmitting a second TCI activation message that maps the first codepoint to a third unified TCI state and the second codepoint to a fourth unified TCI state; means for transmitting, during a TCI activation time for the second TCI activation message, a TCI indication message that indicates a codepoint identifier indication; and/or means for transmitting or receiving a communication using a unified TCI state that corresponds to a codepoint of the second TCI activation message that matches the codepoint identifier indication, the unified TCI state being applied after an end of the TCI activation time for the second TCI activation message.

In some aspects, the UE includes means for receiving a first TCI activation message that maps a first codepoint to a first unified TCI state and a second codepoint to a second unified TCI state; means for receiving a second TCI activation message that maps the first codepoint to a third unified TCI state and the second codepoint to a fourth unified TCI state; means for receiving a first TCI indication message that indicates a first codepoint identifier indication; means for refraining from applying any unified TCI states indicated after the second TCI activation message and before an end of a TCI application time for the first TCI indication message; and/or means for transmitting or receiving a communication using a unified TCI state of whichever of the first TCI activation message or the second TCI activation message has a codepoint that matches the first codepoint identifier indication.

In some aspects, the network entity includes means for transmitting a first TCI activation message that maps a first codepoint to a first unified TCI state and a second codepoint to a second unified TCI state; means for transmitting a second TCI activation message that maps the first codepoint to a third unified TCI state and the second codepoint to a fourth unified TCI state; means for transmitting a TCI indication message that indicates a codepoint identifier indication; means for refraining from applying any unified TCI states indicated after the second TCI activation message and before an end of a TCI application time for the TCI indication message; and/or means for transmitting or receiving a communication using a unified TCI state of whichever of the first TCI activation message or the second TCI activation message has a codepoint that matches the codepoint identifier indication.

In some aspects, the UE includes means for receiving a first TCI activation message that maps a first codepoint to a first unified TCI state and a second codepoint to a second unified TCI state; means for receiving a second TCI activation message that maps the first codepoint to a third unified TCI state and the second codepoint to a fourth unified TCI state; means for receiving, during a TCI activation time for the second TCI activation message, a first TCI indication message that indicates a first codepoint identifier indication; means for refraining from applying a matching unified TCI state of a matching codepoint of the second TCI activation message that matches the first codepoint identifier indication until after receiving a second TCI indication message that indicates a second codepoint identifier indication that is different than the first codepoint identifier indication; and/or means for transmitting or receiving a communication using the matching unified TCI state, the matching unified TCI state being applied after receiving the second TCI indication message. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for transmitting a first TCI activation message that maps a first codepoint to a first unified TCI state and a second codepoint to a second unified TCI state; means for transmitting a second TCI activation message that maps the first codepoint to a third unified TCI state and the second codepoint to a fourth unified TCI state; means for transmitting, during a TCI activation time for the second TCI activation message, a first TCI indication message that indicates a first codepoint identifier indication; means for refraining from applying a matching unified TCI state of a matching codepoint of the second TCI activation message that matches the first codepoint identifier indication until after transmitting a second TCI indication message that indicates a second codepoint identifier indication that is different than the first codepoint identifier indication; and/or means for transmitting or receiving a communication using the matching unified TCI state, the matching unified TCI state being applied after transmitting the second TCI indication message.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

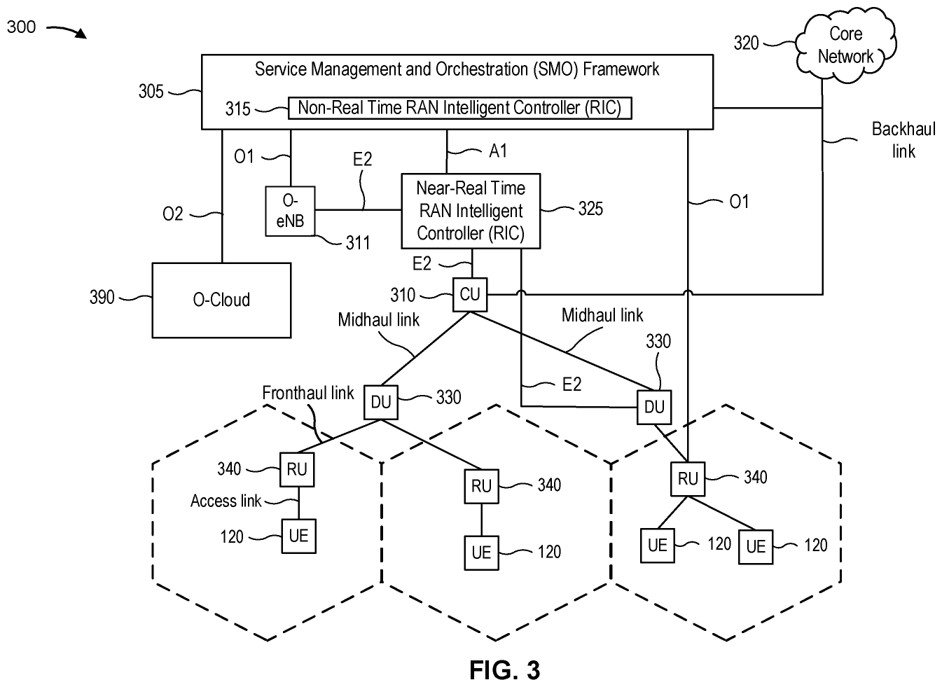

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of using beams for communications between a base station and a UE, in accordance with the present disclosure. As shown in FIG. 4, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each BS transmit beam 405 may be associated with a synchronization signal block (SSB), and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

In some aspects, the base station 110 may transmit a TCI activation message that includes codepoints (bits in fields) that are mapped to TCI states. For example, the TCI activation MAC CE 412 in example 400 may map a first codepoint (T₀) to TCII, a second codepoint (T1) to TCI5, and so forth. The base station 110 may then transmit a TCI indication message in downlink control information (DCI) that includes a code identifier indication that indicates a codepoint among the multiple codepoints. The UE 120 is to activate and use the TCI state that is mapped to the codepoint.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A, and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

3GPP standards Release 17 established a unified TCI state framework in which a TCI state may be used to indicate more than one beam. The TCI state may be used to indicate beams for a downlink channel or reference signal (RS) and/or an uplink channel or RS. There may be multiple types of unified TCI states. For example, a joint downlink/uplink common TCI state may indicate a common beam for at least one downlink channel or RS and at least one uplink channel or RS. A separate downlink common TCI state may indicate a common beam for more than one downlink channel or RS. A separate uplink common TCI state may indicate a common beam for more than one uplink channel or RS. Other types of unified TCI states may include a separate downlink single channel or RS TCI state that indicates a beam for a single downlink channel or RS, a separate uplink single channel or RS TCI state that indicates a beam for a single uplink channel or RS, or an uplink spatial relation information, such as a spatial relation indicator (SRI), that indicates a beam for a single uplink channel or RS.

As indicated above, FIG. 4 is provided as an example. Other examples may differ from what is described with respect to FIG. 4.

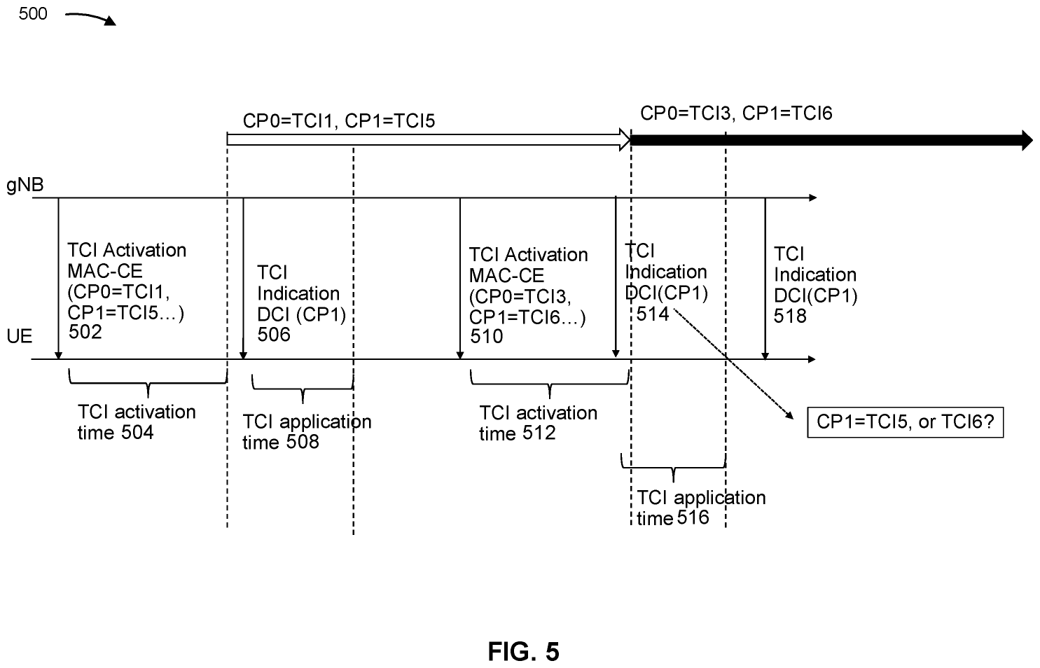

FIG. 5 is a diagram illustrating an example 500 of TCI activation and application times, in accordance with the present disclosure.

Example 500 shows that a network entity (e.g., gNB) may transmit a TCI activation message, such as a TCI activation MAC CE 502, to a UE. The TCI activation MAC CE 502 may map codepoints to TCI states, such as a first codepoint (CP0) to TCI1 and a second codepoint (CP1) to TCI5. There may be other codepoints mapped to other TCI states. The TCI activation MAC CE 502 may have a TCI activation time 504 during which the UE stores the mapping and prepares for activation of a TCI state. The TCI activation time 504 may start after a hybrid automatic repeat request (HARQ) acknowledgement (ACK), or HARQ-ACK, for the TCI activation MAC CE 502. After the TCI activation time 504, the UE use the mapping of CP0 to TCI1 and CP1 to TCI5. In other words, after the TCI activation time 504, the UE may activate TCI1 and TCI5 for TCI codepoints. For example, when the UE is to transmit a physical uplink control channel (PUCCH) communication with HARQ-ACK information in slot n corresponding to the physical downlink shared channel (PDSCH) communication carrying the TCI activation command, the indicated mapping between TCI states and codepoints of the DCI field ‘Transmission Configuration Indication’ should be applied starting from the first slot that is after slot n+3Nₛₗₒₜ^{subframe,μ} where m is the subcarrier spacing (SCS) configuration for the PUCCH.

The gNB may transmit a TCI indication DCI 506 with a codepoint identifier indication, such as CP1. The UE may have a TCI application time 508, after which the UE applies the TCI state associated with CP1. The application time may start after a HARQ-ACK. For example, when the UE is to transmit the last symbol of a PUCCH communication with HARQ-ACK information corresponding to the DCI carrying the codepoint identifier indication (TCI-State indication) and without a downlink assignment, or corresponding to the PDSCH scheduling by the DCI carrying the TCI-State indication, and if the indicated TCI-State is different from the previously indicated one, the indicated TCI-State with a type of unified TCI state (e.g., tci-StateId_r17) is to be applied starting from the first slot that is at least a time (e.g., BeamAppTime_r17) symbols after the last symbol of the PUCCH. After the TCI application time 508, the UE can start to apply the indicated TCI-state associated with CP1 to applicable channels associated with the TCI-state.

Example 500 shows that the gNB may transmit another TCI activation MAC CE 510 with a different codepoint-to-TCI state mapping. The TCI activation MAC CE 510 may have a TCI activation time 512. After the TCI activation time 512, the UE can use the mapping of CP0 to TCI3 and CP1 to TCI6. In other words, after the TCI activation time 512, the UE can activate the TCI3 and TCI6 for the TCI codepoints. However, the UE may receive TCI indication DCI 514 (for CP1 with a TCI application time 516) during TCI activation time 512. The codepoint identifier indication of TCI indication DCI 514 may indicate CP1. There is ambiguity at the UE as to whether the UE is to use the TCI state of CP1 of TCI activation MAC CE 502 or of CP1 of TCI activation MAC CE 510 if TCI indication DCI 514 is received during TCI activation time 512 but the corresponding indicated TCI (indicated by the codepoint identifier indication) is to be applied after TCI activation time 512. CP1 could mean TCI5 (for TCI activation MAC CE 502) or TCI6 (for TCI activation MAC CE 510). In other words, when the UE is activated with TCI states by a MAC CE between a DCI indicating a TCI state and when the indicated TCI state is to take effect, it has not been specified what TCI state the UE is to apply. Without a clear selection for the TCI state, the UE may not select an optimum TCI state and communications may degrade. Degraded communications waste processing resources and signaling resources.

As indicated above, FIG. 5 is provided as an example. Other examples may differ from what is described with regard to FIG. 5.

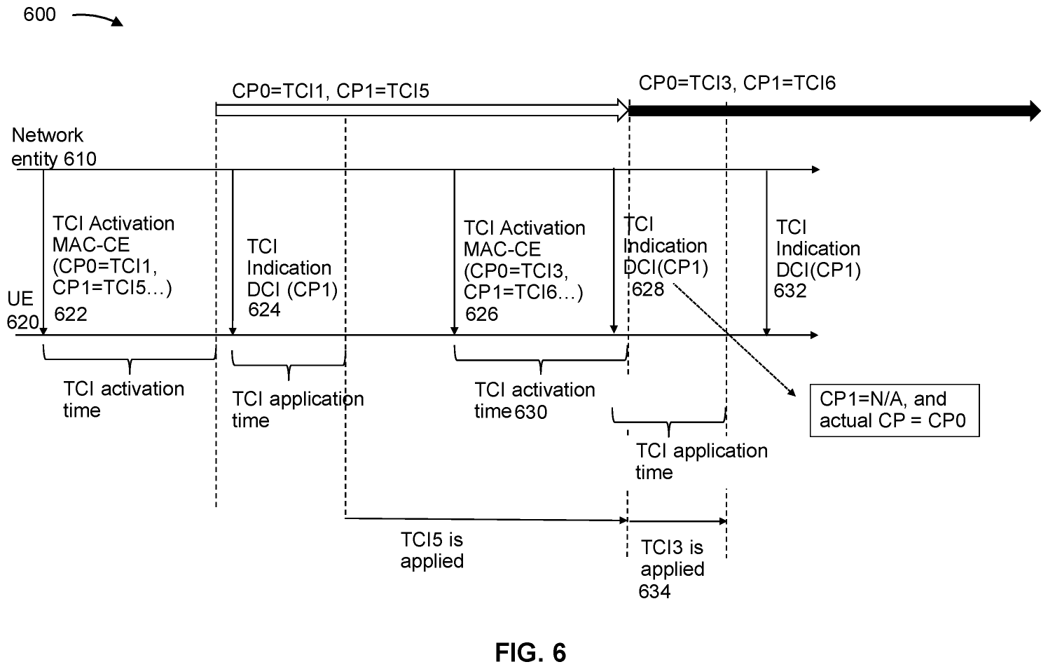

FIG. 6 is a diagram illustrating an example 600 associated with TCI activation, in accordance with the present disclosure. As shown in FIG. 6, a network entity 610 (e.g., base station 110) and a UE 620 (e.g., a UE 120) may communicate with one another.

According to various aspects described herein, the UE 620 may select a TCI state to apply according to a rule. For example 600, that rule may be that, between a time that the UE 620 receives a DCI indicating a TCI in a TCI codepoint to a time that the UE 620 applies the indicated TCI based on the DCI, if the UE 620 should activate new TCIs to the TCI codepoints by a TCI activation MAC CE, the UE 620 is to apply the lowest activated TCI codepoint in the TCI activation MAC CE for all the applicable channels after the TCI activation. The applicable channels and/or reference signals may be based at least in part on the unified TCI state and/or higher-layer configurations. For example, if the unified TCI state is a joint TCI state, both uplink and downlink channels are to apply an indicated TCI state. By clarifying which TCI state the UE 620 is to apply, TCI state selection may avoid degraded communications. As a result, the network entity 610 and the UE 620 may conserve processing resources and signaling resources.

The network entity 610 may transmit TCI activation MAC CE 622, which maps, among other codepoints, CP0 to TCI1 and CP1 to TCI5. The network entity 610 may transmit TCI indication DCI 624 with a codepoint identifier indication for CP1. After a TCI application time, TCI5 is applied, as TCI5 is mapped to CP1 by TCI activation MAC CE 622.

The network entity 610 may transmit TCI activation MAC CE 626, which maps, among other codepoints, CP0 to TCI3 and CP1 to TCI6. The network entity 610 may transmit TCI indication DCI 628 with a codepoint identifier indication for CP1 during TCI activation time 630.

In some aspects, if TCI indication DCI 628 is received during TCI activation time 630 of TCI activation MAC CE 626 and is to indicate a TCI codepoint with TCIs to be applied after TCI activation time 630 of TCI activation MAC CE 626, the UE 620 may apply a unified TCI state of a codepoint of TCI activation MAC CE 626 with a predetermined identifier after TCI activation time 630. For example, the predetermined identifier may be the lowest identifier or the highest identifier. In example 600, the codepoint with the lowest identifier is CP0, and the corresponding unified TCI state is TCI3. As shown by reference number 634, the UE 620 may apply TCI3 for uplink and downlink communications after an end of TCI activation time 630.

In some aspects, after a TCI activation time of a TCI activation MAC CE, the UE 620 may apply a unified TCI state of a codepoint with a predetermined identifier of the TCI activation MAC CE for applicable channels associated with the unified TCI state, until the UE 620 is to apply a different TCI by a unified TCI indication DCI indicating a TCI codepoint with the different TCI activated by the TCI activation MAC CE. For example, the predetermined identifier may be the lowest identifier or the highest identifier. In example 600, for TCI activation MAC CE 626, the codepoint with the lowest identifier is CP0, and the corresponding unified TCI state is TCI3. After an end of TCI activation time 630 of TCI activation MAC CE 626, the UE 620 may apply TC13 for uplink and/or downlink communications applicable to TCI3 until the UE 620 is to apply a new TCI (e.g., TCI6) indicated by the TCI codepoint CP1 in TCI indication DCI 632 with the new TCI activated by TCI activation MAC CE 626.

As indicated above, FIG. 6 is provided as an example. Other examples may differ from what is described with respect to FIG. 6.

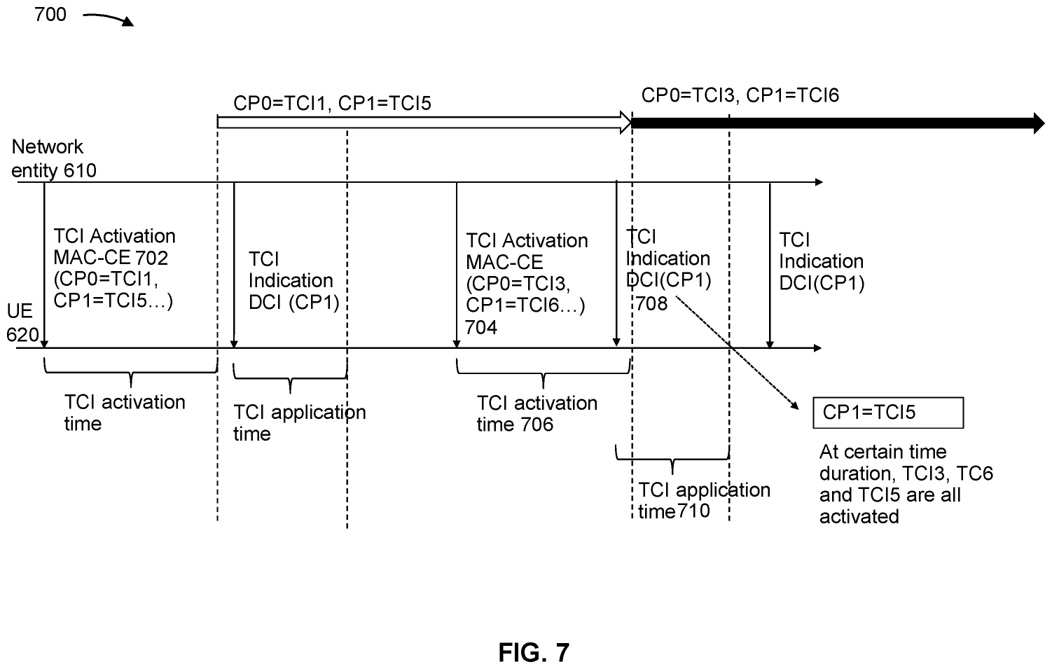

FIG. 7 is a diagram illustrating an example 700 associated with TCI activation, in accordance with the present disclosure.

In some aspects, the UE 620 may select a TCI state to apply according to a rule that specifies that, when the UE 620 is to apply TCIs in a TCI codepoint indicated in a DCI, the UE 620 may select the indicated TCIs based at least in part on the TCI codepoint at the time when TCO indication DCI 708 is received. That is, the UE 620 may receive a first TCI activation MAC CE 702 and a second TCI activation MAC CE 704. At the time when TCI indication DCI 708 is received, TCI activation MAC CE 704 is still during its TCI application time, and the mapping between TCI codepoints and TCI states is based on TCI activation MAC CE 702. If the UE 620 receives, during TCI activation time 706 for TCI activation MAC CE 704, a TCI indication DCI 708 (i.e., a unified TCI indication DCI) that indicates a codepoint identifier indication, the UE 620 may transmit or receive a communication using a unified TCI state that corresponds to a codepoint of TCI activation MAC CE 702 that matches the codepoint identifier indication. The UE 620 may apply the unified TCI state based at least in part on TCI activation MAC CE 702 after an end of the TCI application time 710 for TCI indication DCI 708 and after an end of TCI activation time 706 for TCI activation MAC CE 704. In this way, the UE 620 has sufficient time to prepare the beam based on TCI indication DCI 708.

Example 700 shows that, based on this rule, the UE 620 is to apply TCI5, as TCI5 maps to CP1 for the first TCI activation MAC CE.

As indicated above, FIG. 7 is provided as an example. Other examples may differ from what is described with respect to FIG. 7.

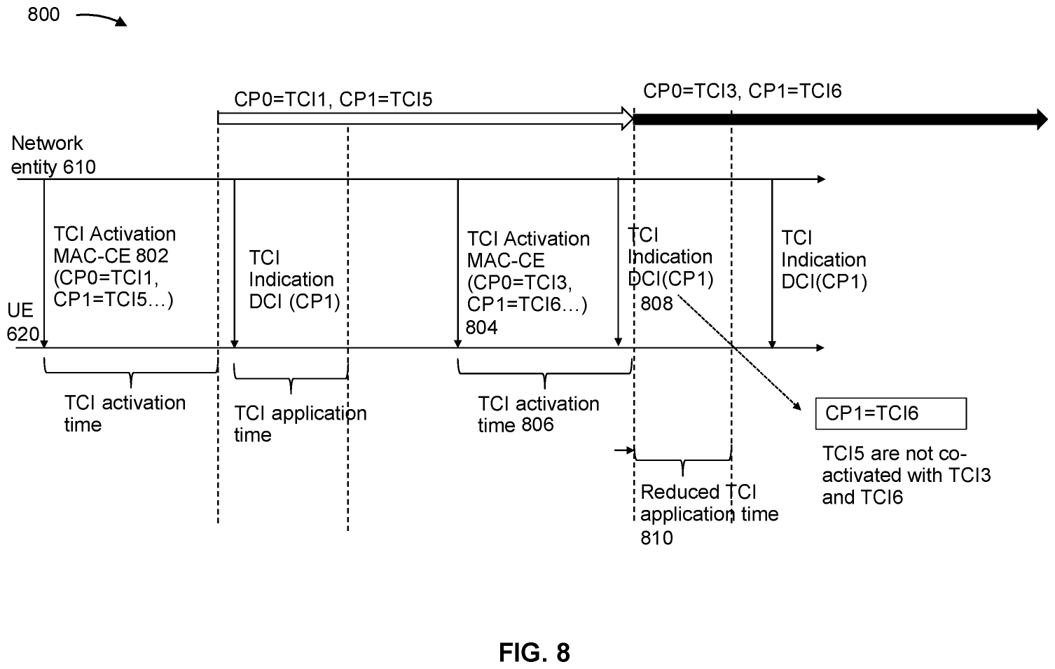

FIG. 8 is a diagram illustrating an example 800 associated with TCI activation, in accordance with the present disclosure.

In some aspects, the UE 620 may select a TCI state to apply according to a rule that specifies that, when the UE 620 is to apply TCIs in a TCI codepoint indicated in a DCI, the UE 620 may select the indicated TCIs based at least in part on the latest TCI codepoint that has been activated by the TCI activation MAC CE. That is, the UE 620 may receive a first TCI activation MAC CE 802 and a second TCI activation MAC CE 804. If the UE 620 receives, during a TCI activation time 806 for TCI activation MAC CE 804, a TCI indication message 808 (i.e., a unified TCI indication DCI) that indicates a codepoint identifier indication with TCIs to be applied after TCI activation time 806 for TCI activation MAC CE 804, the UE 620 may transmit or receive a communication using a unified TCI state that corresponds to a codepoint of TCI activation MAC CE 804 that matches the codepoint identifier indication. The UE 620 may apply the unified TCI state after an end of TCI application time 810 for TCI indication DCI 808 and after an end of TCI activation time 806 for TCI activation MAC CE 804. In this way, the UE 620 does not need to maintain TCIs that are not activated by the latest TCI activation MAC CE, which conserves processing resources.

Example 800 shows that, based on this rule, the UE 620 is to apply TCI6, as TCI6 maps to CP1 for the second TCI activation MAC CE 804.

As indicated above, FIG. 8 is provided as an example. Other examples may differ from what is described with respect to FIG. 8.

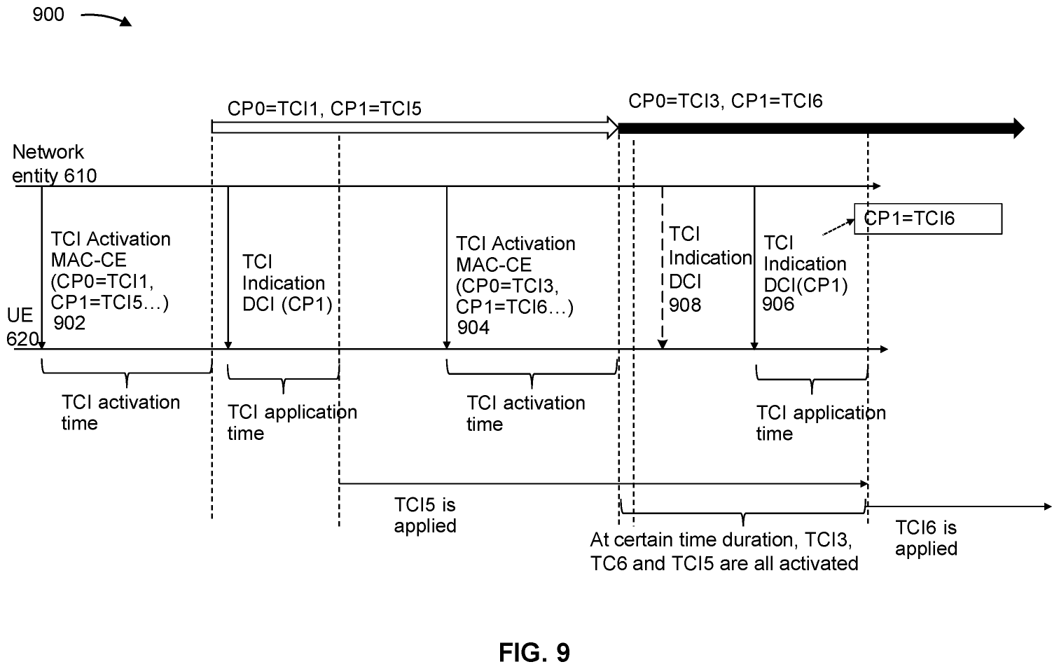

FIG. 9 is a diagram illustrating an example 900 associated with TCI activation, in accordance with the present disclosure.

In some aspects, the UE 620 may select a TCI state to apply according to a rule that specifies that, from a time that the UE 620 receives a DCI indicating a TCI to a time that the UE 620 applies the indicated TCI based on the DCI, the UE 620 does not expect to be activated with new TCIs to the TCI codepoints by any TCI activation MAC CE. New TCIs are TCI indication DCIs or TCI activation MAC CEs that are received during this time. That is, the UE 620 may receive a first TCI activation MAC CE 902 and a second TCI activation MAC CE 904. The UE 620 may transmit or receive a communication using a unified TCI state of whichever of the first TCI activation MAC CE 902 and a second TCI activation MAC CE 904 matches a codepoint identifier indication of TCI indication DCI 906. That is, a codepoint of a TCI activation MAC CE should match the codepoint identifier indication. This may be the second TCI activation MAC CE 904 or the first TCI activation MAC CE 902 (if there is no matching codepoint in the second TCI activation MAC CE 904). However, the UE 620 may refrain or wait to apply the unified TCI state until after an end of the application time for the TCI indication DCI 906.

Example 900 shows that, based on this rule, the UE 620 is to apply TCI6, as TCI6 maps to CP1 for the second TCI activation MAC CE 904. No other TCI states indicated after the TCI activation MAC CE 904 are applied, even if TCI indication 908 were received.

As indicated above, FIG. 9 is provided as an example. Other examples may differ from what is described with respect to FIG. 9.

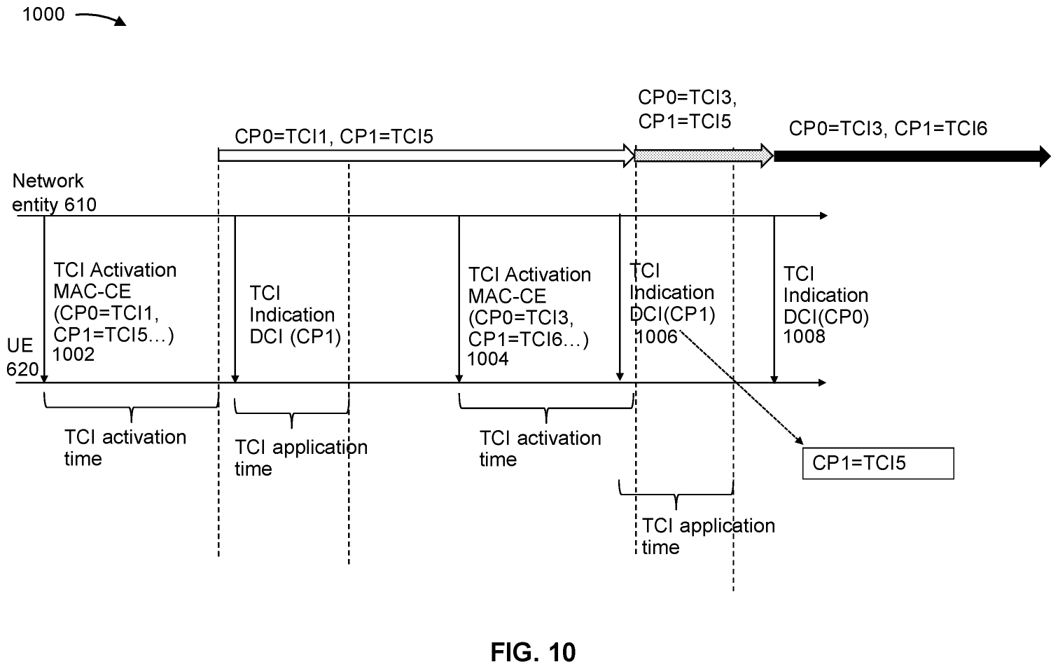

FIG. 10 is a diagram illustrating an example 1000 associated with TCI activation, in accordance with the present disclosure.

In some aspects, the UE 620 may select a TCI state to apply according to a rule that specifies that, between a time that the UE 620 receives a DCI indicating a TCI in a TCI codepoint to a time that the UE 620 applies the indicated TCI based on the DCI, if the UE 620 should activate new TCIs to the TCI codepoints by a TCI activation MAC CE, the UE 620 postpones the TCI activation for the TCI codepoint until a new DCI indicating a different codepoint is received after the TCI activation. That is, the UE 620 may receive a first TCI activation MAC CE 1002 and a second TCI activation MAC CE 1004. The UE 620 may receive a TCI indication DCI 1006.

Example 1000 shows that, based on this rule, the UE 620 is to refrain from applying a matching unified TCI state of a matching codepoint of the second TCI activation MAC CE 1004 that matches a first codepoint identifier indication of TCI indication DCI 1006 until after receiving TCI indication DCI 1008, which indicates a second codepoint identifier indication that is different than the first codepoint identifier indication. The UE 620 may apply TCI6 for CP1 (matches first codepoint identifier indication of CP1) when TCI indication DCI 1008 is received, but not before then. In the meantime, TCI5 continues to be activated for CP1 for TCI activation MAC CE 1002. The UE 620 may apply TCI3, as TCI3 maps to CP0 for the TCI activation MAC CE 1004 and CP0 is different than CP1 (CPO does not match first codepoint identifier indication of CP1). By waiting on application of a matching unified TCI state for CP1 of TCI indication DCI 1006, received during the TCI activation time of TCI activation MAC CE 1004, and continuing with applying non-matching unified TCI states of other codepoints (not CP1), the UE 620 may have time to apply the new indication while not maintaining more older TCI states than necessary. As a result, the UE 620 may conserve processing resources.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120, UE 620) performs operations associated with TCI state activation.

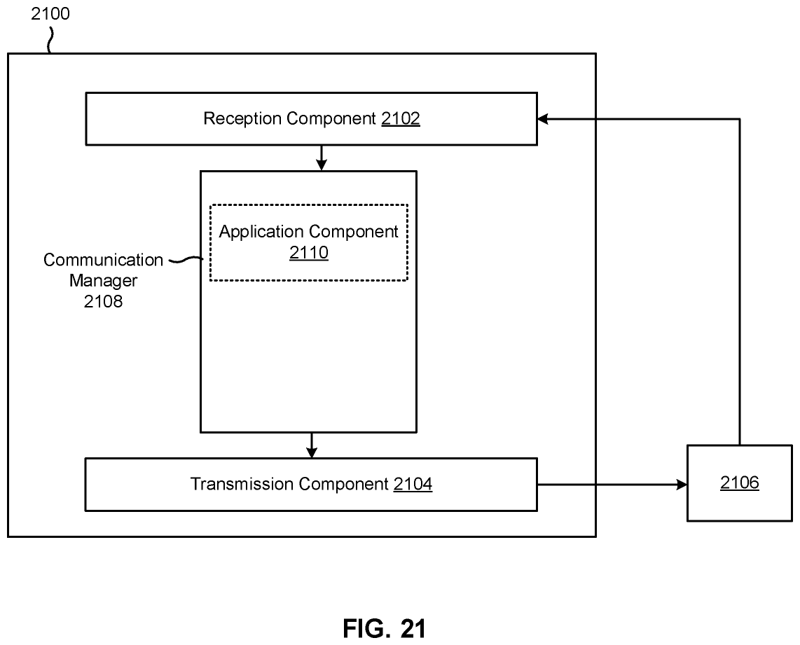

As shown in FIG. 11, in some aspects, process 1100 may include receiving a first TCI activation message that maps a first codepoint to a first unified TCI state and a second codepoint to a second unified TCI state (block 1110). For example, the UE (e.g., using communication manager 2108 and/or reception component 2102 depicted in FIG. 21) may receive a first TCI activation message that maps a first codepoint to a first unified TCI state and a second codepoint to a second unified TCI state, as described above.

As further shown in FIG. 11, in some aspects, process 1100 may include receiving a second TCI activation message that maps the first codepoint to a third unified TCI state and the second codepoint to a fourth unified TCI state (block 1120). For example, the UE (e.g., using communication manager 2108 and/or reception component 2102 depicted in FIG. 21) may receive a second TCI activation message that maps the first codepoint to a third unified TCI state and the second codepoint to a fourth unified TCI state, as described above.

As further shown in FIG. 11, in some aspects, process 1100 may include receiving, during a TCI activation time for the second TCI activation message, a TCI indication message that indicates a codepoint identifier indication for the first codepoint or the second codepoint (block 1130). For example, the UE (e.g., using communication manager 2108 and/or reception component 2102 depicted in FIG. 21) may receive, during a TCI activation time for the second TCI activation message, a TCI indication message that indicates a codepoint identifier indication for the first codepoint or the second codepoint, as described above.

As further shown in FIG. 11, in some aspects, process 1100 may include transmitting or receiving a communication using a unified TCI state of a codepoint of the second TCI activation message with a lowest identifier, the unified TCI state being applied after an end of the TCI activation time for the second TCI activation message (block 1140). For example, the UE (e.g., using communication manager 2108, reception component 210, and/or transmission component 2104 depicted in FIG. 21) may transmit or receive a communication using a unified TCI state of a codepoint of the second TCI activation message with a lowest identifier, the unified TCI state being applied after an end of the TCI activation time for the second TCI activation message, as described above.

Process 1100 may include additional aspects, such as any single aspect or any combination of aspects described below and/or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

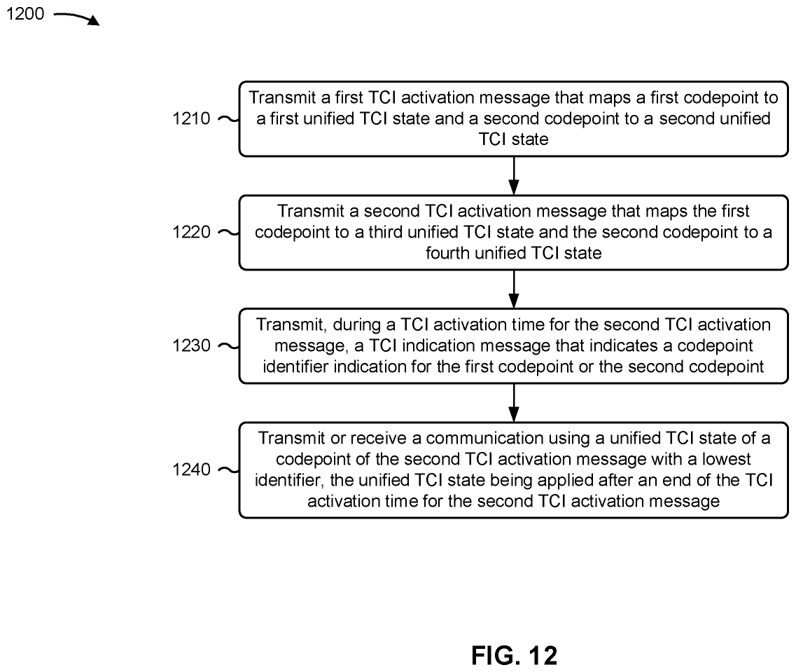

FIG. 12 is a diagram illustrating an example process 1200 performed, for example, by a network entity, in accordance with the present disclosure. Example process 1200 is an example where the network entity (e.g., network entity 610) performs operations associated with TCI state activation.

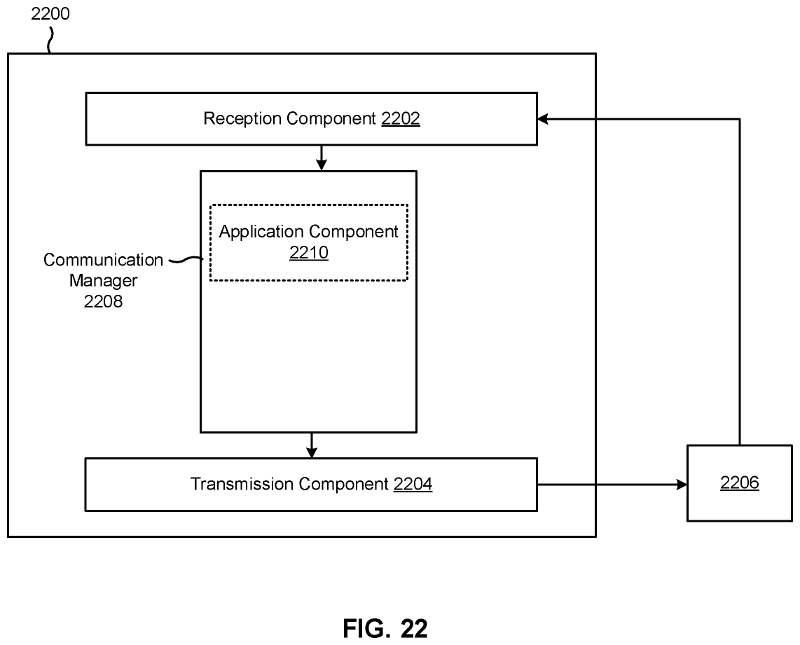

As shown in FIG. 12, in some aspects, process 1200 may include transmitting a first TCI activation message that maps a first codepoint to a first unified TCI state and a second codepoint to a second unified TCI state (block 1210). For example, the network entity (e.g., using communication manager 2208 and/or transmission component 2204 depicted in FIG. 22) may transmit a first TCI activation message that maps a first codepoint to a first unified TCI state and a second codepoint to a second unified TCI state, as described above.

As further shown in FIG. 12, in some aspects, process 1200 may include transmitting a second TCI activation message that maps the first codepoint to a third unified TCI state and the second codepoint to a fourth unified TCI state (block 1220). For example, the network entity (e.g., using communication manager 2208 and/or transmission component 2204 depicted in FIG. 22) may transmit a second TCI activation message that maps the first codepoint to a third unified TCI state and the second codepoint to a fourth unified TCI state, as described above.

As further shown in FIG. 12, in some aspects, process 1200 may include transmitting, during a TCI activation time for the second TCI activation message, a TCI indication message that indicates a codepoint identifier indication for the first codepoint or the second codepoint (block 1230). For example, the network entity (e.g., using communication manager 2208 and/or transmission component 2204 depicted in FIG. 22) may transmit, during a TCI activation time for the second TCI activation message, a TCI indication message that indicates a codepoint identifier indication for the first codepoint or the second codepoint, as described above.

As further shown in FIG. 12, in some aspects, process 1200 may include transmitting or receiving a communication using a unified TCI state of a codepoint of the second TCI activation message with a lowest identifier, the unified TCI state being applied after an end of the TCI activation time for the second TCI activation message (block 1240). For example, the network entity (e.g., using communication manager 2208, reception component 2202, and/or transmission component 2204 depicted in FIG. 22) may transmit or receive a communication using a unified TCI state of a codepoint of the second TCI activation message with a lowest identifier, the unified TCI state being applied after an end of the TCI activation time for the second TCI activation message, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

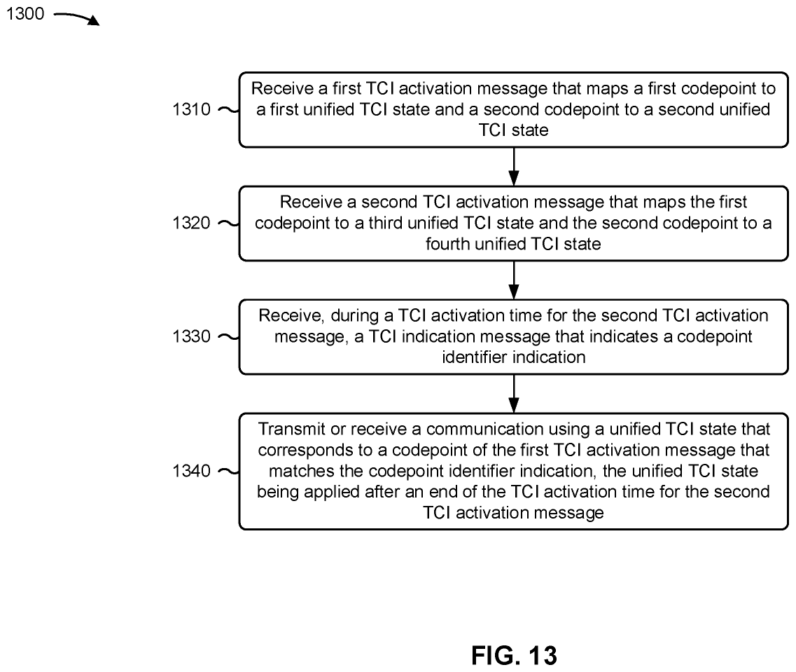

FIG. 13 is a diagram illustrating an example process 1300 performed, for example, by a UE, in accordance with the present disclosure. Example process 1300 is an example where the UE (e.g., UE 120, UE 620) performs operations associated with TCI state activation.

As shown in FIG. 13, in some aspects, process 1300 may include receiving a first TCI activation message that maps a first codepoint to a first unified TCI state and a second codepoint to a second unified TCI state (block 1310). For example, the UE (e.g., using communication manager 2108 and/or reception component 2102 depicted in FIG. 21) may receive a first TCI activation message that maps a first codepoint to a first unified TCI state and a second codepoint to a second unified TCI state, as described above.

As further shown in FIG. 13, in some aspects, process 1300 may include receiving a second TCI activation message that maps the first codepoint to a third unified TCI state and the second codepoint to a fourth unified TCI state (block 1320). For example, the UE (e.g., using communication manager 2108 and/or reception component 2102 depicted in FIG. 21) may receive a second TCI activation message that maps the first codepoint to a third unified TCI state and the second codepoint to a fourth unified TCI state, as described above.

As further shown in FIG. 13, in some aspects, process 1300 may include receiving, during a TCI activation time for the second TCI activation message, a TCI indication message that indicates a codepoint identifier indication (block 1330). For example, the UE (e.g., using communication manager 2108 and/or reception component 2102 depicted in FIG. 21) may receive, during a TCI activation time for the second TCI activation message, a TCI indication message that indicates a codepoint identifier indication, as described above.

As further shown in FIG. 13, in some aspects, process 1300 may include transmitting or receiving a communication using a unified TCI state that corresponds to a codepoint of the first TCI activation message that matches the codepoint identifier indication, the unified TCI state being applied after an end of the TCI activation time for the second TCI activation message (block 1340). For example, the UE (e.g., using communication manager 2108, reception component 2102, and/or transmission component 2104 depicted in FIG. 21) may transmit or receive a communication using a unified TCI state that corresponds to a codepoint of the first TCI activation message that matches the codepoint identifier indication, the unified TCI state being applied after an end of the TCI activation time for the second TCI activation message, as described above.

Process 1300 may include additional aspects, such as any single aspect or any combination of aspects described below and/or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

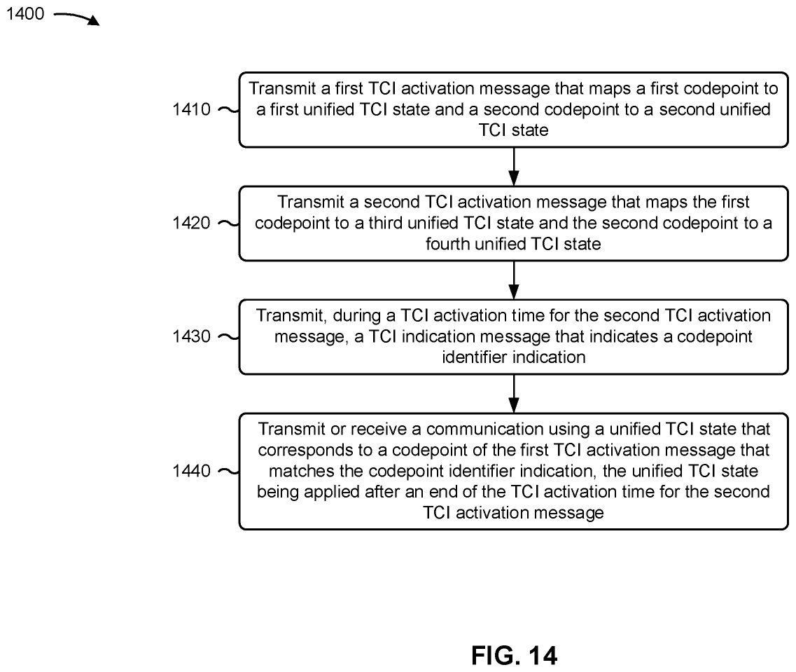

FIG. 14 is a diagram illustrating an example process 1400 performed, for example, by a network entity, in accordance with the present disclosure. Example process 1400 is an example where the network entity (e.g., network entity 610) performs operations associated with TCI state activation.

As shown in FIG. 14, in some aspects, process 1400 may include transmitting a first TCI activation message that maps a first codepoint to a first unified TCI state and a second codepoint to a second unified TCI state (block 1410). For example, the network entity (e.g., using communication manager 2208 and/or transmission component 2204 depicted in FIG. 22) may transmit a first TCI activation message that maps a first codepoint to a first unified TCI state and a second codepoint to a second unified TCI state, as described above.

As further shown in FIG. 14, in some aspects, process 1400 may include transmitting a second TCI activation message that maps the first codepoint to a third unified TCI state and the second codepoint to a fourth unified TCI state (block 1420). For example, the network entity (e.g., using communication manager 2208 and/or transmission component 2204 depicted in FIG. 22) may transmit a second TCI activation message that maps the first codepoint to a third unified TCI state and the second codepoint to a fourth unified TCI state, as described above.

As further shown in FIG. 14, in some aspects, process 1400 may include transmitting, during a TCI activation time for the second TCI activation message, a TCI indication message that indicates a codepoint identifier indication (block 1430). For example, the network entity (e.g., using communication manager 2208 and/or transmission component 2204 depicted in FIG. 22) may transmit, during a TCI activation time for the second TCI activation message, a TCI indication message that indicates a codepoint identifier indication, as described above.

As further shown in FIG. 14, in some aspects, process 1400 may include transmitting or receiving a communication using a unified TCI state that corresponds to a codepoint of the first TCI activation message that matches the codepoint identifier indication, the unified TCI state being applied after an end of the TCI activation time for the second TCI activation message (block 1440). For example, the network entity (e.g., using communication manager 2208, reception component 2202, and/or transmission component 2204 depicted in FIG. 22) may transmit or receive a communication using a unified TCI state that corresponds to a codepoint of the first TCI activation message that matches the codepoint identifier indication, the unified TCI state being applied after an end of the TCI activation time for the second TCI activation message, as described above.

Process 1400 may include additional aspects, such as any single aspect or any combination of aspects described below and/or in connection with one or more other processes described elsewhere herein.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

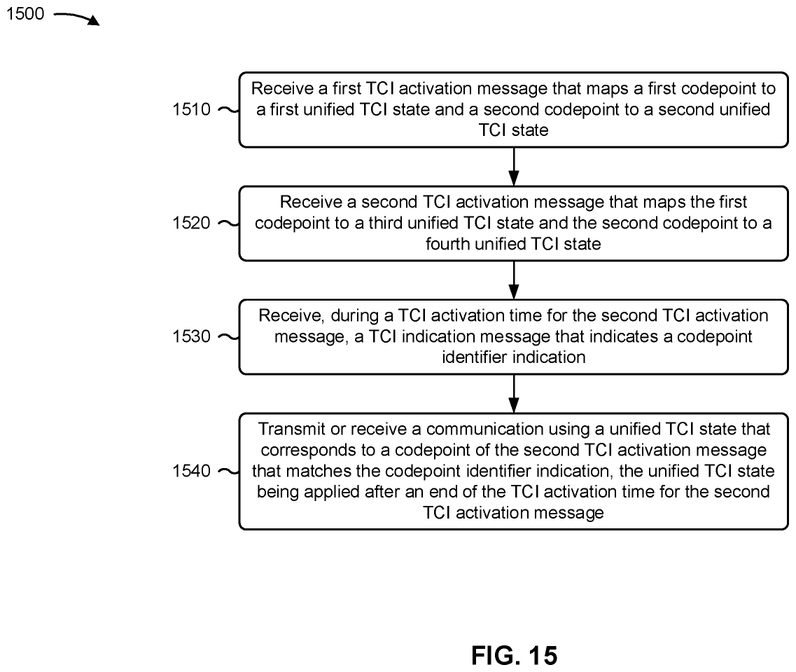

FIG. 15 is a diagram illustrating an example process 1500 performed, for example, by a UE, in accordance with the present disclosure. Example process 1500 is an example where the UE (e.g., UE 120, UE 620) performs operations associated with activation of unified transmission configuration.

As shown in FIG. 15, in some aspects, process 1500 may include receiving a first TCI activation message that maps a first codepoint to a first unified TCI state and a second codepoint to a second unified TCI state (block 1510). For example, the UE (e.g., using communication manager 2108 and/or reception component 2102 depicted in FIG. 21) may receive a first TCI activation message that maps a first codepoint to a first unified TCI state and a second codepoint to a second unified TCI state, as described above.

As further shown in FIG. 15, in some aspects, process 1500 may include receiving a second TCI activation message that maps the first codepoint to a third unified TCI state and the second codepoint to a fourth unified TCI state (block 1520). For example, the UE (e.g., using communication manager 2108 and/or reception component 2102 depicted in FIG. 21) may receive a second TCI activation message that maps the first codepoint to a third unified TCI state and the second codepoint to a fourth unified TCI state, as described above.

As further shown in FIG. 15, in some aspects, process 1500 may include receiving, during a TCI activation time for the second TCI activation message, a TCI indication message that indicates a codepoint identifier indication (block 1530). For example, the UE (e.g., using communication manager 2108 and/or reception component 2102 depicted in FIG. 21) may receive, during a TCI activation time for the second TCI activation message, a TCI indication message that indicates a codepoint identifier indication, as described above.

As further shown in FIG. 15, in some aspects, process 1500 may include transmitting or receiving a communication using a unified TCI state that corresponds to a codepoint of the second TCI activation message that matches the codepoint identifier indication, the unified TCI state being applied after an end of the TCI activation time for the second TCI activation message (block 1540). For example, the UE (e.g., using communication manager 2108 and/or transmission component 2204 depicted in FIG. 21) may transmit or receive a communication using a unified TCI state that corresponds to a codepoint of the second TCI activation message that matches the codepoint identifier indication, the unified TCI state being applied after an end of the TCI activation time for the second TCI activation message, as described above.

Process 1500 may include additional aspects, such as any single aspect or any combination of aspects described below and/or in connection with one or more other processes described elsewhere herein.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

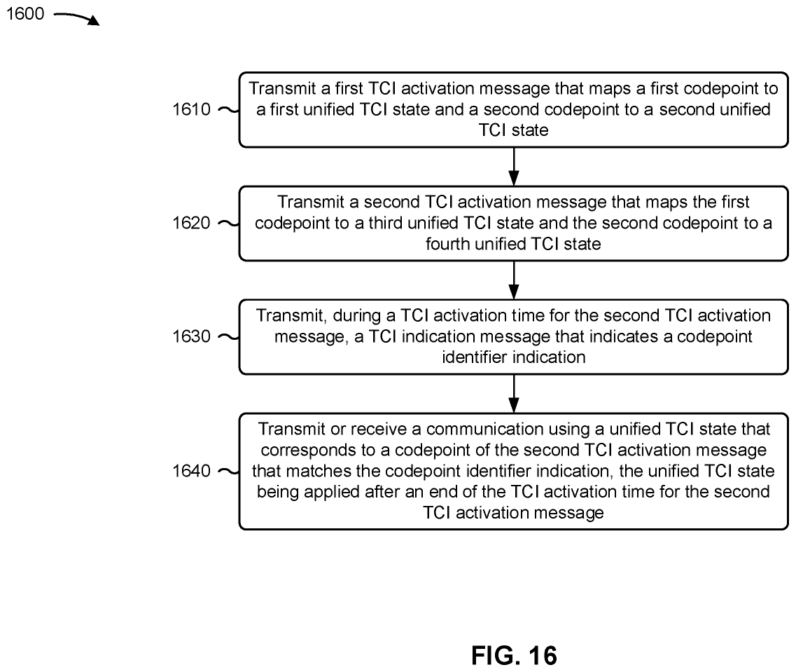

FIG. 16 is a diagram illustrating an example process 1600 performed, for example, by a network entity, in accordance with the present disclosure. Example process 1600 is an example where the network entity (e.g., network entity 610) performs operations associated with TCI state activation.

As shown in FIG. 16, in some aspects, process 1600 may include transmitting a first TCI activation message that maps a first codepoint to a first unified TCI state and a second codepoint to a second unified TCI state (block 1610). For example, the network entity (e.g., using communication manager 2208 and/or transmission component 2204 depicted in FIG. 22 may transmit a first TCI activation message that maps a first codepoint to a first unified TCI state and a second codepoint to a second unified TCI state, as described above.

As further shown in FIG. 16, in some aspects, process 1600 may include transmitting a second TCI activation message that maps the first codepoint to a third unified TCI state and the second codepoint to a fourth unified TCI state (block 1620). For example, the network entity (e.g., using communication manager 2208 and/or transmission component 2204 depicted in FIG. 22) may transmit a second TCI activation message that maps the first codepoint to a third unified TCI state and the second codepoint to a fourth unified TCI state, as described above.

As further shown in FIG. 16, in some aspects, process 1600 may include transmitting, during a TCI activation time for the second TCI activation message, a TCI indication message that indicates a codepoint identifier indication (block 1630). For example, the network entity (e.g., using communication manager 2208 and/or transmission component 2204 depicted in FIG. 22) may transmit, during a TCI activation time for the second TCI activation message, a TCI indication message that indicates a codepoint identifier indication, as described above.

As further shown in FIG. 16, in some aspects, process 1600 may include transmitting or receiving a communication using a unified TCI state that corresponds to a codepoint of the second TCI activation message that matches the codepoint identifier indication, the unified TCI state being applied after an end of the TCI activation time for the second TCI activation message (block 1640). For example, the network entity (e.g., using communication manager 2208, reception component 2202, and/or transmission component 2204 depicted in FIG. 22) may transmit or receive a communication using a unified TCI state that corresponds to a codepoint of the second TCI activation message that matches the codepoint identifier indication, the unified TCI state being applied after an end of the TCI activation time for the second TCI activation message, as described above.

Process 1600 may include additional aspects, such as any single aspect or any combination of aspects described below and/or in connection with one or more other processes described elsewhere herein.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

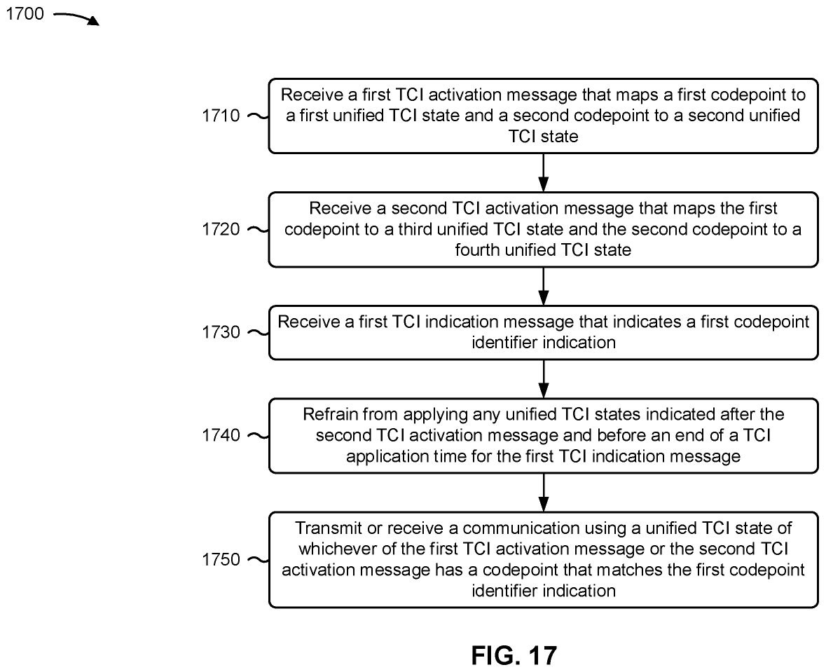

FIG. 17 is a diagram illustrating an example process 1700 performed, for example, by a UE, in accordance with the present disclosure. Example process 1700 is an example where the UE (e.g., UE 120, UE 620) performs operations associated with TCI state activation.

As shown in FIG. 17, in some aspects, process 1700 may include receiving a first TCI activation message that maps a first codepoint to a first unified TCI state and a second codepoint to a second unified TCI state (block 1710). For example, the UE (e.g., using communication manager 2108 and/or reception component 2102 depicted in FIG. 21) may receive a first TCI activation message that maps a first codepoint to a first unified TCI state and a second codepoint to a second unified TCI state, as described above.

As further shown in FIG. 17, in some aspects, process 1700 may include receiving a second TCI activation message that maps the first codepoint to a third unified TCI state and the second codepoint to a fourth unified TCI state (block 1720). For example, the UE (e.g., using communication manager 2108 and/or reception component 2102 depicted in FIG. 21) may receive a second TCI activation message that maps the first codepoint to a third unified TCI state and the second codepoint to a fourth unified TCI state, as described above.

As further shown in FIG. 17, in some aspects, process 1700 may include receiving a first TCI indication message that indicates a first codepoint identifier indication (block 1730). For example, the UE (e.g., using communication manager 2108 and/or reception component 2102 depicted in FIG. 21) may receive a first TCI indication message that indicates a first codepoint identifier indication, as described above.

As further shown in FIG. 17, in some aspects, process 1700 may include refraining from applying any unified TCI states indicated after the second TCI activation message and before an end of a TCI application time for the first TCI indication message (block 1740). For example, the UE (e.g., using communication manager 2108 and/or application component 2110 depicted in FIG. 21) may refrain from applying any unified TCI states indicated after the second TCI activation message and before an end of a TCI application time for the first TCI indication message, as described above.

As further shown in FIG. 17, in some aspects, process 1700 may include transmitting or receiving a communication using a unified TCI state of whichever of the first TCI activation message or the second TCI activation message has a codepoint that matches the first codepoint identifier indication (block 1750). For example, the UE (e.g., using communication manager 2108, reception component 2102, and/or transmission component 2104 depicted in FIG. 21) may transmit or receive a communication using a unified TCI state of whichever of the first TCI activation message or the second TCI activation message has a codepoint that matches the first codepoint identifier indication, as described above.

Process 1700 may include additional aspects, such as any single aspect or any combination of aspects described below and/or in connection with one or more other processes described elsewhere herein.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

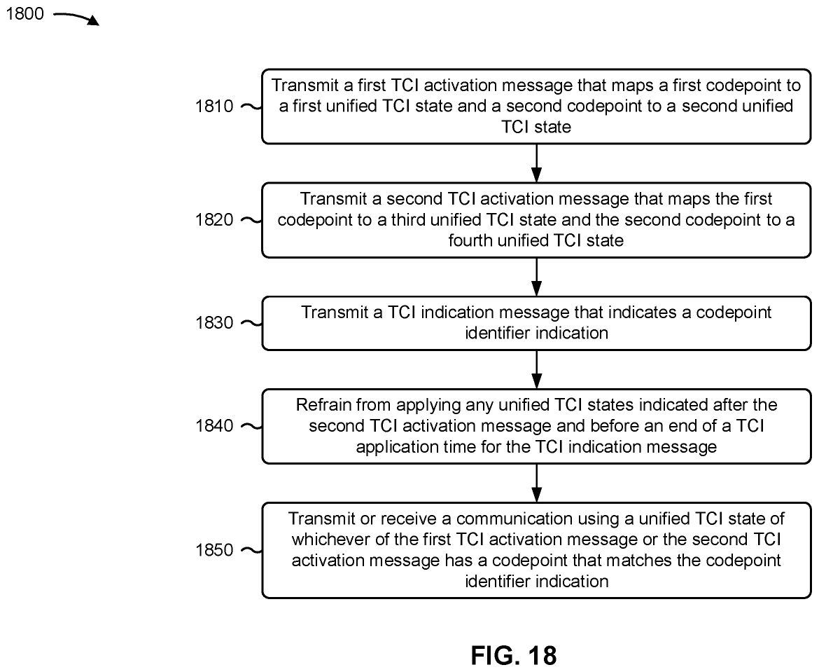

FIG. 18 is a diagram illustrating an example process 1800 performed, for example, by a network entity, in accordance with the present disclosure. Example process 1800 is an example where the network entity (e.g., network entity 610) performs operations associated with TCI state activation.

As shown in FIG. 18, in some aspects, process 1800 may include transmitting a first TCI activation message that maps a first codepoint to a first unified TCI state and a second codepoint to a second unified TCI state (block 1810). For example, the network entity (e.g., using communication manager 2208 and/or transmission component 2204 depicted in FIG. 22) may transmit a first TCI activation message that maps a first codepoint to a first unified TCI state and a second codepoint to a second unified TCI state, as described above.

As further shown in FIG. 18, in some aspects, process 1800 may include transmitting a second TCI activation message that maps the first codepoint to a third unified TCI state and the second codepoint to a fourth unified TCI state (block 1820). For example, the network entity (e.g., using communication manager 2208 and/or transmission component 2204 depicted in FIG. 22) may transmit a second TCI activation message that maps the first codepoint to a third unified TCI state and the second codepoint to a fourth unified TCI state, as described above.

As further shown in FIG. 18, in some aspects, process 1800 may include transmitting a TCI indication message that indicates a codepoint identifier indication (block 1830). For example, the network entity (e.g., using communication manager 2208 and/or transmission component 2204 depicted in FIG. 22) may transmit a TCI indication message that indicates a codepoint identifier indication, as described above.

As further shown in FIG. 18, in some aspects, process 1800 may include refraining from applying any unified TCI states indicated after the second TCI activation message and before an end of a TCI application time for the TCI indication message (block 1840). For example, the network entity (e.g., using communication manager 2208 and/or application component 2210 depicted in FIG. 22) may refrain from applying any unified TCI states indicated after the second TCI activation message and before an end of a TCI application time for the TCI indication message, as described above.

As further shown in FIG. 18, in some aspects, process 1800 may include transmitting or receiving a communication using a unified TCI state of whichever of the first TCI activation message or the second TCI activation message has a codepoint that matches the codepoint identifier indication (block 1850). For example, the network entity (e.g., using communication manager 2208, reception component 2202, and/or transmission component 2204 depicted in FIG. 22) may transmit or receive a communication using a unified TCI state of whichever of the first TCI activation message or the second TCI activation message has a codepoint that matches the codepoint identifier indication, as described above.

Process 1800 may include additional aspects, such as any single aspect or any combination of aspects described below and/or in connection with one or more other processes described elsewhere herein.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

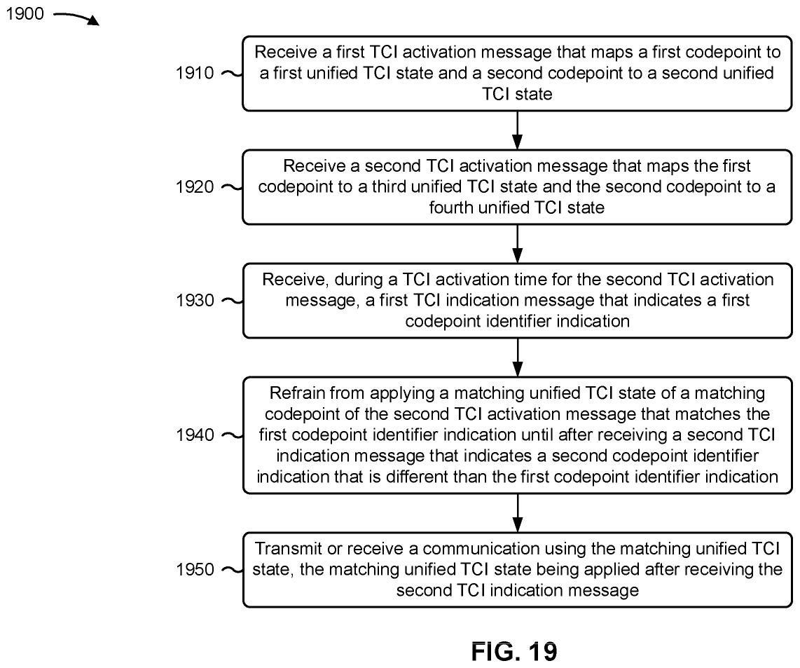

FIG. 19 is a diagram illustrating an example process 1900 performed, for example, by a UE, in accordance with the present disclosure. Example process 1900 is an example where the UE (e.g., UE 120, UE 620) performs operations associated with TCI state activation.

As shown in FIG. 19, in some aspects, process 1900 may include receiving a first TCI activation message that maps a first codepoint to a first unified TCI state and a second codepoint to a second unified TCI state (block 1910). For example, the UE (e.g., using communication manager 2108 and/or reception component 2102 depicted in FIG. 21) may receive a first TCI activation message that maps a first codepoint to a first unified TCI state and a second codepoint to a second unified TCI state, as described above.

As further shown in FIG. 19, in some aspects, process 1900 may include receiving a second TCI activation message that maps the first codepoint to a third unified TCI state and the second codepoint to a fourth unified TCI state (block 1920). For example, the UE (e.g., using communication manager 2108 and/or reception component 2102 depicted in FIG. 21) may receive a second TCI activation message that maps the first codepoint to a third unified TCI state and the second codepoint to a fourth unified TCI state, as described above.

As further shown in FIG. 19, in some aspects, process 1900 may include receiving, during a TCI activation time for the second TCI activation message, a first TCI indication message that indicates a first codepoint identifier indication (block 1930). For example, the UE (e.g., using communication manager 2108 and/or reception component 2102 depicted in FIG. 21) may receive, during a TCI activation time for the second TCI activation message, a first TCI indication message that indicates a first codepoint identifier indication, as described above.

As further shown in FIG. 19, in some aspects, process 1900 may include refraining from applying a matching unified TCI state of a matching codepoint of the second TCI activation message that matches the first codepoint identifier indication until after receiving a second TCI indication message that indicates a second codepoint identifier indication that is different than the first codepoint identifier indication (block 1940). For example, the UE (e.g., using communication manager 2108 and/or application component 2110 depicted in FIG. 21) may refrain from applying a matching unified TCI state of a matching codepoint of the second TCI activation message that matches the first codepoint identifier indication until after receiving a second TCI indication message that indicates a second codepoint identifier indication that is different than the first codepoint identifier indication, as described above.

As further shown in FIG. 19, in some aspects, process 1900 may include transmitting or receiving a communication using the matching unified TCI state, the matching unified TCI state being applied after receiving the second TCI indication message (block 1950). For example, the UE (e.g., using communication manager 2108, transmission component 2104, and/or reception component 2102 depicted in FIG. 21) may transmit or receive a communication using the matching unified TCI state, the matching unified TCI state being applied after receiving the second TCI indication message, as described above.

Process 1900 may include additional aspects, such as any single aspect or any combination of aspects described below and/or in connection with one or more other processes described elsewhere herein.

In an aspect, process 1900 includes applying a non-matching unified TCI state of a non-matching codepoint of the first TCI activation message that does not match the first codepoint identifier indication, the non-matching unified TCI state being applied at an end of the TCI activation time for the second TCI activation message.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

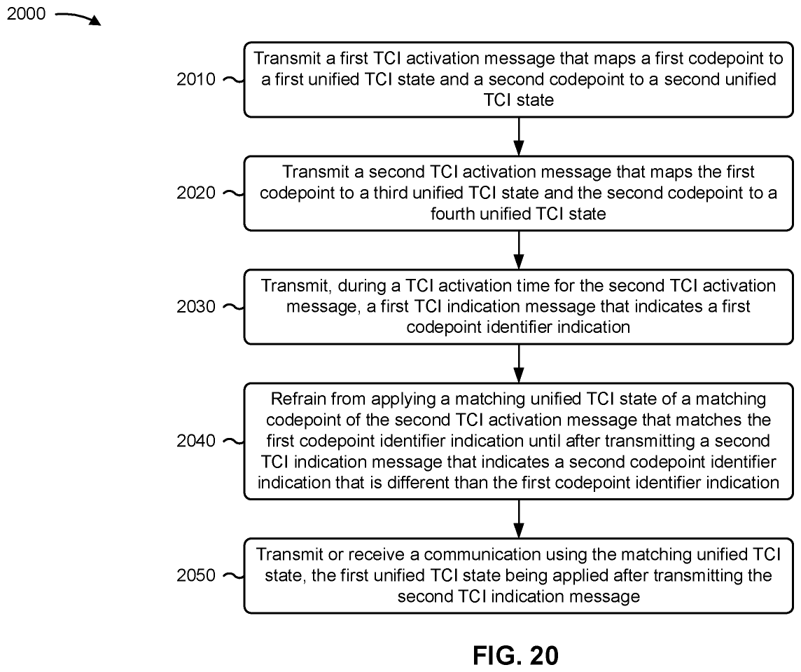

FIG. 20 is a diagram illustrating an example process 2000 performed, for example, by a network entity, in accordance with the present disclosure. Example process 2000 is an example where the network entity (e.g., network entity 610) performs operations associated with TCI state activation.

As shown in FIG. 20, in some aspects, process 2000 may include transmitting a first TCI activation message that maps a first codepoint to a first unified TCI state and a second codepoint to a second unified TCI state (block 2010). For example, the network entity (e.g., using communication manager 2208 and/or transmission component 2204 depicted in FIG. 22) may transmit a first TCI activation message that maps a first codepoint to a first unified TCI state and a second codepoint to a second unified TCI state, as described above.

As further shown in FIG. 20, in some aspects, process 2000 may include transmitting a second TCI activation message that maps the first codepoint to a third unified TCI state and the second codepoint to a fourth unified TCI state (block 2020). For example, the network entity (e.g., using communication manager 2208 and/or transmission component 2204 depicted in FIG. 22) may transmit a second TCI activation message that maps the first codepoint to a third unified TCI state and the second codepoint to a fourth unified TCI state, as described above.

As further shown in FIG. 20, in some aspects, process 2000 may include transmitting, during a TCI activation time for the second TCI activation message, a first TCI indication message that indicates a first codepoint identifier indication (block 2030). For example, the network entity (e.g., using communication manager 2208 and/or transmission component 2204 depicted in FIG. 22) may transmit, during a TCI activation time for the second TCI activation message, a first TCI indication message that indicates a first codepoint identifier indication, as described above.

As further shown in FIG. 20, in some aspects, process 2000 may include refraining from applying a matching unified TCI state of a matching codepoint of the second TCI activation message that matches the first codepoint identifier indication until after transmitting a second TCI indication message that indicates a second codepoint identifier indication that is different than the first codepoint identifier indication (block 2040). For example, the network entity (e.g., using communication manager 2208 and/or application component 2210 depicted in FIG. 22) may refrain from applying a matching unified TCI state of a matching codepoint of the second TCI activation message that matches the first codepoint identifier indication until after transmitting a second TCI indication message that indicates a second codepoint identifier indication that is different than the first codepoint identifier indication, as described above.

As further shown in FIG. 20, in some aspects, process 2000 may include transmitting or receiving a communication using the matching unified TCI state, the matching unified TCI state being applied after transmitting the second TCI indication message (block 2050). For example, the network entity (e.g., using communication manager 2208, reception component 2202, and/or transmission component 2204 depicted in FIG. 22) may transmit or receive a communication using the matching unified TCI state, the matching unified TCI state being applied after transmitting the second TCI indication message, as described above.

Process 2000 may include additional aspects, such as any single aspect or any combination of aspects described below and/or in connection with one or more other processes described elsewhere herein.

In an aspect, process 2000 includes applying a non-matching unified TCI state of a non-matching codepoint of the first TCI activation message that does not match the first codepoint identifier indication, the non-matching unified TCI state being applied at an end of the TCI activation time for the second TCI activation message.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram of an example apparatus 2100 for wireless communication. The apparatus 2100 may be a UE (e.g., a UE 120, UE 620), or a UE may include the apparatus 2100. In some aspects, the apparatus 2100 includes a reception component 2102 and a transmission component 2104, which may be in communication with one another (for example, via one or more buses and/or one or more other components). As shown, the apparatus 2100 may communicate with another apparatus 2106 (such as a UE, a base station, or another wireless communication device) using the reception component 2102 and the transmission component 2104. As further shown, the apparatus 2100 may include the communication manager 140. The communication manager 2108 may control and/or otherwise manage one or more operations of the reception component 2102 and/or the transmission component 2104. In some aspects, the communication manager 2108 may include one or more antennas, a modem, a controller/processor, a memory, or a combination thereof, of the UE described in connection with FIG. 2. The communication manager 2108 may be, or be similar to, the communication manager 150 depicted in FIGS. 1 and 2. For example, in some aspects, the communication manager 2108 may be configured to perform one or more of the functions described as being performed by the communication manager 150. In some aspects, the communication manager 2108 may include the reception component 2102 and/or the transmission component 2104. The communication manager 2108 may include an application component 2110, among other examples.

In some aspects, the apparatus 2100 may be configured to perform one or more operations described herein in connection with FIGS. 1-10. Additionally, or alternatively, the apparatus 2100 may be configured to perform one or more processes described herein, such as process 1100 of FIG. 11, process 1300 of FIG. 13, process 1500 of FIG. 15, process 1700 of FIG. 17, process 1900 of FIG. 19, or a combination thereof. In some aspects, the apparatus 2100 and/or one or more components shown in FIG. 21 may include one or more components of the UE described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2106. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a demodulator, a MIMO detector, a receive processor, a controller/processor, a memory, or a combination thereof, of the UE described in connection with FIG. 2.

The transmission component 2104 may transmit communications, such as reference signals, control information, data communications, or a combination thereof, to the apparatus 2106. In some aspects, one or more other components of the apparatus 2100 may generate communications and may provide the generated communications to the transmission component 2104 for transmission to the apparatus 2106. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2106. In some aspects, the transmission component 2104 may include one or more antennas, a modem, a modulator, a transmit MIMO processor, a transmit processor, a controller/processor, a memory, or a combination thereof, of the UE described in connection with FIG. 2. In some aspects, the transmission component 2104 may be co-located with the reception component 2102 in a transceiver.

In some aspects, the reception component 2102 may receive a first TCI activation message that maps a first codepoint to a first unified TCI state and a second codepoint to a second unified TCI state. The reception component 2102 may receive a second TCI activation message that maps the first codepoint to a third unified TCI state and the second codepoint to a fourth unified TCI state. The reception component 2102 may receive, during a TCI activation time for the second TCI activation message, a TCI indication message that indicates a codepoint identifier indication for the first codepoint or the second codepoint. The transmission component 2104 may transmit or receive a communication using a unified TCI state of a codepoint of the second TCI activation message with a lowest identifier, the unified TCI state being applied after an end of the TCI activation time for the second TCI activation message.

In some aspects, the reception component 2102 may receive a first TCI activation message that maps a first codepoint to a first unified TCI state and a second codepoint to a second unified TCI state. The reception component 2102 may receive a second TCI activation message that maps the first codepoint to a third unified TCI state and the second codepoint to a fourth unified TCI state. The reception component 2102 may receive, during a TCI activation time for the second TCI activation message, a TCI indication message that indicates a codepoint identifier indication. The transmission component 2104 may transmit or receive a communication using a unified TCI state that corresponds to a codepoint of the first TCI activation message that matches the codepoint identifier indication, the unified TCI state being applied after an end of the TCI activation time for the second TCI activation message.

In some aspects, the reception component 2102 may receive a first TCI activation message that maps a first codepoint to a first unified TCI state and a second codepoint to a second unified TCI state. The reception component 2102 may receive a second TCI activation message that maps the first codepoint to a third unified TCI state and the second codepoint to a fourth unified TCI state. The reception component 2102 may receive, during a TCI activation time for the second TCI activation message, a TCI indication message that indicates a codepoint identifier indication. The transmission component 2104 may transmit or receive a communication using a unified TCI state that corresponds to a codepoint of the second TCI activation message that matches the codepoint identifier indication, the unified TCI state being applied after an end of the TCI activation time for the second TCI activation message.

In some aspects, the reception component 2102 may receive a first TCI activation message that maps a first codepoint to a first unified TCI state and a second codepoint to a second unified TCI state. The reception component 2102 may receive a second TCI activation message that maps the first codepoint to a third unified TCI state and the second codepoint to a fourth unified TCI state. The reception component 2102 may receive a first TCI indication message that indicates a first codepoint identifier indication. The application component 2110 may refrain from applying any unified TCI states indicated after the second TCI activation message and before an end of a TCI application time for the first TCI indication message. The transmission component 2104 may transmit or receive a communication using a unified TCI state of whichever of the first TCI activation message or the second TCI activation message has a codepoint that matches the first codepoint identifier indication.

In some aspects, the reception component 2102 may receive a first TCI activation message that maps a first codepoint to a first unified TCI state and a second codepoint to a second unified TCI state. The reception component 2102 may receive a second TCI activation message that maps the first codepoint to a third unified TCI state and the second codepoint to a fourth unified TCI state. The reception component 2102 may receive, during a TCI activation time for the second TCI activation message, a first TCI indication message that indicates a first codepoint identifier indication. The application component 2110 may refrain from applying a matching unified TCI state of a matching codepoint of the second TCI activation message that matches the first codepoint identifier indication until after receiving a second TCI indication message that indicates a second codepoint identifier indication that is different than the first codepoint identifier indication. The transmission component 2104 may transmit or receive a communication using the matching unified TCI state, the matching unified TCI state being applied after receiving the second TCI indication message.

The application component 2110 may apply a non-matching unified TCI state of a non-matching codepoint of the first TCI activation message that does not match the first codepoint identifier indication, the non-matching unified TCI state being applied at an end of the TCI activation time for the second TCI activation message.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

FIG. 22 is a diagram of an example apparatus 2200 for wireless communication. The apparatus 2200 may be a network entity (e.g., base station 110, network entity 610), or a network entity may include the apparatus 2200. In some aspects, the apparatus 2200 includes a reception component 2202 and a transmission component 2204, which may be in communication with one another (for example, via one or more buses and/or one or more other components). As shown, the apparatus 2200 may communicate with another apparatus 2206 (such as a UE, a base station, or another wireless communication device) using the reception component 2202 and the transmission component 2204. As further shown, the apparatus 2200 may include the communication manager 2208. The communication manager 2208 may control and/or otherwise manage one or more operations of the reception component 2202 and/or the transmission component 2204. In some aspects, the communication manager 2208 may include one or more antennas, a modem, a controller/processor, a memory, or a combination thereof, of the base station described in connection with FIG. 2. The communication manager 2208 may be, or be similar to, the communication manager 150 depicted in FIGS. 1 and 2. For example, in some aspects, the communication manager 2208 may be configured to perform one or more of the functions described as being performed by the communication manager 150. In some aspects, the communication manager 2208 may include the reception component 2202 and/or the transmission component 2204. The communication manager 2208 may include an application component 2210, among other examples.

In some aspects, the apparatus 2200 may be configured to perform one or more operations described herein in connection with FIGS. 1-10. Additionally, or alternatively, the apparatus 2200 may be configured to perform one or more processes described herein, such as process 1200 of FIG. 12, process 1400 of FIG. 13, process 1600 of FIG. 16., process 1800 of FIG. 18, process 2000 of FIG. 20, or a combination thereof. In some aspects, the apparatus 2200 and/or one or more components shown in FIG. 22 may include one or more components of the network entity described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2206. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the network entity described in connection with FIG. 2.

The transmission component 2204 may transmit communications, such as reference signals, control information, data communications, or a combination thereof, to the apparatus 2206. In some aspects, one or more other components of the apparatus 2200 may generate communications and may provide the generated communications to the transmission component 2204 for transmission to the apparatus 2206. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2206. In some aspects, the transmission component 2204 may include one or more antennas, a modem, a modulator, a transmit MIMO processor, a transmit processor, a controller/processor, a memory, or a combination thereof, of the network entity described in connection with FIG. 2. In some aspects, the transmission component 2204 may be co-located with the reception component 2202 in a transceiver.

In some aspects, the transmission component 2204 may transmit a first TCI activation message that maps a first codepoint to a first unified TCI state and a second codepoint to a second unified TCI state. The transmission component 2204 may transmit a second TCI activation message that maps the first codepoint to a third unified TCI state and the second codepoint to a fourth unified TCI state. The transmission component 2204 may transmit, during a TCI activation time for the second TCI activation message, a TCI indication message that indicates a codepoint identifier indication for the first codepoint or the second codepoint. The transmission component 2204 may transmit or receive a communication using a unified TCI state of a codepoint of the second TCI activation message with a lowest identifier, the unified TCI state being applied after an end of the TCI activation time for the second TCI activation message.

In some aspects, the transmission component 2204 may transmit a first TCI activation message that maps a first codepoint to a first unified TCI state and a second codepoint to a second unified TCI state. The transmission component 2204 may transmit a second TCI activation message that maps the first codepoint to a third unified TCI state and the second codepoint to a fourth unified TCI state. The transmission component 2204 may transmit, during a TCI activation time for the second TCI activation message, a TCI indication message that indicates a codepoint identifier indication. The transmission component 2204 may transmit or receive a communication using a unified TCI state that corresponds to a codepoint of the first TCI activation message that matches the codepoint identifier indication, the unified TCI state being applied after an end of the TCI activation time for the second TCI activation message.

In some aspects, the transmission component 2204 may transmit a first TCI activation message that maps a first codepoint to a first unified TCI state and a second codepoint to a second unified TCI state. The transmission component 2204 may transmit a second TCI activation message that maps the first codepoint to a third unified TCI state and the second codepoint to a fourth unified TCI state. The transmission component 2204 may transmit, during a TCI activation time for the second TCI activation message, a TCI indication message that indicates a codepoint identifier indication. The transmission component 2204 may transmit or receive a communication using a unified TCI state that corresponds to a codepoint of the second TCI activation message that matches the codepoint identifier indication, the unified TCI state being applied after an end of the TCI activation time for the second TCI activation message.

In some aspects, the transmission component 2204 may transmit a first TCI activation message that maps a first codepoint to a first unified TCI state and a second codepoint to a second unified TCI state. The transmission component 2204 may transmit a second TCI activation message that maps the first codepoint to a third unified TCI state and the second codepoint to a fourth unified TCI state. The transmission component 2204 may transmit a TCI indication message that indicates a codepoint identifier indication. The application component 2210 may refrain from applying any unified TCI states indicated after the second TCI activation message and before an end of a TCI application time for the TCI indication message. The transmission component 2204 may transmit or receive a communication using a unified TCI state of whichever of the first TCI activation message or the second TCI activation message has a codepoint that matches the codepoint identifier indication.

In some aspects, the transmission component 2204 may transmit a first TCI activation message that maps a first codepoint to a first unified TCI state and a second codepoint to a second unified TCI state. The transmission component 2204 may transmit a second TCI activation message that maps the first codepoint to a third unified TCI state and the second codepoint to a fourth unified TCI state. The transmission component 2204 may transmit, during a TCI activation time for the second TCI activation message, a first TCI indication message that indicates a first codepoint identifier indication. The application component 2210 may refrain from applying a matching unified TCI state of a matching codepoint of the second TCI activation message that matches the first codepoint identifier indication until after transmitting a second TCI indication message that indicates a second codepoint identifier indication that is different than the first codepoint identifier indication. The transmission component 2204 may transmit or receive a communication using the matching unified TCI state, the matching unified TCI state being applied after transmitting the second TCI indication message.

The application component 2210 may apply a non-matching unified TCI state of a non-matching codepoint of the first TCI activation message that does not match the first codepoint identifier indication, the non-matching unified TCI state being applied at an end of the TCI activation time for the second TCI activation message.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

The following provides an overview of some Aspects of the present disclosure:

Aspect 1: A method of wireless communication performed by a user equipment (UE), comprising: receiving a first transmission configuration indicator (TCI) activation message that maps a first codepoint to a first unified TCI state and a second codepoint to a second unified TCI state; receiving a second TCI activation message that maps the first codepoint to a third unified TCI state and the second codepoint to a fourth unified TCI state; receiving, during a TCI activation time for the second TCI activation message, a TCI indication message that indicates a codepoint identifier indication for the first codepoint or the second codepoint; and transmitting or receiving a communication using a unified TCI state of a codepoint of the second TCI activation message with a lowest identifier, the unified TCI state being applied after an end of the TCI activation time for the second TCI activation message.

Aspect 2: A method of wireless communication performed by a network entity, comprising: transmitting a first transmission configuration indicator (TCI) activation message that maps a first codepoint to a first unified TCI state and a second codepoint to a second unified TCI state; transmitting a second TCI activation message that maps the first codepoint to a third unified TCI state and the second codepoint to a fourth unified TCI state; transmitting, during a TCI activation time for the second TCI activation message, a TCI indication message that indicates a codepoint identifier indication for the first codepoint or the second codepoint; and transmitting or receiving a communication using a unified TCI state of a codepoint of the second TCI activation message with a lowest identifier, the unified TCI state being applied after an end of the TCI activation time for the second TCI activation message.

Aspect 3: A method of wireless communication performed by a user equipment (UE), comprising: receiving a first transmission configuration indicator (TCI) activation message that maps a first codepoint to a first unified TCI state and a second codepoint to a second unified TCI state; receiving a second TCI activation message that maps the first codepoint to a third unified TCI state and the second codepoint to a fourth unified TCI state; receiving, during a TCI activation time for the second TCI activation message, a TCI indication message that indicates a codepoint identifier indication; and transmitting or receiving a communication using a unified TCI state that corresponds to a codepoint of the first TCI activation message that matches the codepoint identifier indication, the unified TCI state being applied after an end of the TCI activation time for the second TCI activation message.

Aspect 4: A method of wireless communication performed by a network entity, comprising: transmitting a first transmission configuration indicator (TCI) activation message that maps a first codepoint to a first unified TCI state and a second codepoint to a second unified TCI state; transmitting a second TCI activation message that maps the first codepoint to a third unified TCI state and the second codepoint to a fourth unified TCI state; transmitting, during a TCI activation time for the second TCI activation message, a TCI indication message that indicates a codepoint identifier indication; and transmitting or receiving a communication using a unified TCI state that corresponds to a codepoint of the first TCI activation message that matches the codepoint identifier indication, the unified TCI state being applied after an end of the TCI activation time for the second TCI activation message.

Aspect 5: A method of wireless communication performed by a user equipment (UE), comprising: receiving a first transmission configuration indicator (TCI) activation message that maps a first codepoint to a first unified TCI state and a second codepoint to a second unified TCI state; receiving a second TCI activation message that maps the first codepoint to a third unified TCI state and the second codepoint to a fourth unified TCI state; receiving, during a TCI activation time for the second TCI activation message, a TCI indication message that indicates a codepoint identifier indication; and transmitting or receiving a communication using a unified TCI state that corresponds to a codepoint of the second TCI activation message that matches the codepoint identifier indication, the unified TCI state being applied after an end of the TCI activation time for the second TCI activation message.

Aspect 6: A method of wireless communication performed by a network entity, comprising: transmitting a first transmission configuration indicator (TCI) activation message that maps a first codepoint to a first unified TCI state and a second codepoint to a second unified TCI state; transmitting a second TCI activation message that maps the first codepoint to a third unified TCI state and the second codepoint to a fourth unified TCI state; transmitting, during a TCI activation time for the second TCI activation message, a TCI indication message that indicates a codepoint identifier indication; and transmitting or receiving a communication using a unified TCI state that corresponds to a codepoint of the second TCI activation message that matches the codepoint identifier indication, the unified TCI state being applied after an end of the TCI activation time for the second TCI activation message.

Aspect 7: A method of wireless communication performed by a user equipment (UE), comprising: receiving a first transmission configuration indicator (TCI) activation message that maps a first codepoint to a first unified TCI state and a second codepoint to a second unified TCI state; receiving a second TCI activation message that maps the first codepoint to a third unified TCI state and the second codepoint to a fourth unified TCI state; receiving a first TCI indication message that indicates a first codepoint identifier indication; refraining from applying any unified TCI states indicated after the second TCI activation message and before an end of a TCI application time for the first TCI indication message; and transmitting or receiving a communication using a unified TCI state of whichever of the first TCI activation message or the second TCI activation message has a codepoint that matches the first codepoint identifier indication.

Aspect 8: A method of wireless communication performed by a network entity, comprising: transmitting a first transmission configuration indicator (TCI) activation message that maps a first codepoint to a first unified TCI state and a second codepoint to a second unified TCI state; transmitting a second TCI activation message that maps the first codepoint to a third unified TCI state and the second codepoint to a fourth unified TCI state; transmitting a TCI indication message that indicates a codepoint identifier indication; refraining from applying any unified TCI states indicated after the second TCI activation message and before an end of a TCI application time for the TCI indication message; and transmitting or receiving a communication using a unified TCI state of whichever of the first TCI activation message or the second TCI activation message has a codepoint that matches the codepoint identifier indication.

Aspect 9: A method of wireless communication performed by a user equipment (UE), comprising: receiving a first transmission configuration indicator (TCI) activation message that maps a first codepoint to a first unified TCI state and a second codepoint to a second unified TCI state; receiving a second TCI activation message that maps the first codepoint to a third unified TCI state and the second codepoint to a fourth unified TCI state; receiving, during a TCI activation time for the second TCI activation message, a first TCI indication message that indicates a first codepoint identifier indication; refraining from applying a matching unified TCI state of a matching codepoint of the second TCI activation message that matches the first codepoint identifier indication until after receiving a second TCI indication message that indicates a second codepoint identifier indication that is different than the first codepoint identifier indication; and transmitting or receiving a communication using the matching unified TCI state, the matching unified TCI state being applied after receiving the second TCI indication message.

Aspect 10: The method of Aspect 9, further comprising applying a non-matching unified TCI state of a non-matching codepoint of the first TCI activation message that does not match the first codepoint identifier indication, the non-matching unified TCI state being applied at an end of the TCI activation time for the second TCI activation message.

Aspect 11: A method of wireless communication performed by a network entity, comprising: transmitting a first transmission configuration indicator (TCI) activation message that maps a first codepoint to a first unified TCI state and a second codepoint to a second unified TCI state; transmitting a second TCI activation message that maps the first codepoint to a third unified TCI state and the second codepoint to a fourth unified TCI state; transmitting, during a TCI activation time for the second TCI activation message, a first TCI indication message that indicates a first codepoint identifier indication; refraining from applying a matching unified TCI state of a matching codepoint of the second TCI activation message that matches the first codepoint identifier indication until after transmitting a second TCI indication message that indicates a second codepoint identifier indication that is different than the first codepoint identifier indication; and transmitting or receiving a communication using the matching unified TCI state, the matching unified TCI state being applied after transmitting the second TCI indication message.

Aspect 12: The method of Aspect 11, further comprising applying a non-matching unified TCI state of a non-matching codepoint of the first TCI activation message that does not match the first codepoint identifier indication, the non-matching unified TCI state being applied at an end of the TCI activation time for the second TCI activation message.

Aspect 13: An apparatus for wireless communication at a device, comprising a processor; memory coupled with the processor; and instructions stored in the memory and executable by the processor to cause the apparatus to perform the method of one or more of Aspects 1-12.

Aspect 14: A device for wireless communication, comprising a memory and one or more processors coupled to the memory, the one or more processors configured to perform the method of one or more of Aspects 1-12.

Aspect 15: An apparatus for wireless communication, comprising at least one means for performing the method of one or more of Aspects 1-12.

Aspect 16: A non-transitory computer-readable medium storing code for wireless communication, the code comprising instructions executable by a processor to perform the method of one or more of Aspects 1-12.

Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1-12. (canceled)

13. A user equipment (UE) for wireless communication, comprising:
a memory; and
one or more processors, coupled to the memory, configured to:
receive a first transmission configuration indicator (TCI) activation message that maps a first codepoint to a first unified TCI state and a second codepoint to a second unified TCI state;
receive a second TCI activation message that maps the first codepoint to a third unified TCI state and the second codepoint to a fourth unified TCI state;
receive, during a TCI activation time for the second TCI activation message, a TCI indication message that indicates a codepoint identifier indication for the first codepoint or the second codepoint; and
transmit or receive a communication using a unified TCI state of a codepoint of the second TCI activation message with a lowest identifier, the unified TCI state being applied after an end of the TCI activation time for the second TCI activation message.

14-16. (canceled)

17. A user equipment (UE) for wireless communication, comprising:
a memory; and
one or more processors, coupled to the memory, configured to:
receive a first transmission configuration indicator (TCI) activation message that maps a first codepoint to a first unified TCI state and a second codepoint to a second unified TCI state;
receive a second TCI activation message that maps the first codepoint to a third unified TCI state and the second codepoint to a fourth unified TCI state;
receive, during a TCI activation time for the second TCI activation message, a TCI indication message that indicates a codepoint identifier indication; and
transmit or receive a communication using a unified TCI state that corresponds to a codepoint of the second TCI activation message that matches the codepoint identifier indication, the unified TCI state being applied after an end of the TCI activation time for the second TCI activation message.

18. A network entity for wireless communication, comprising:
a memory; and
one or more processors, coupled to the memory, configured to:
transmit a first transmission configuration indicator (TCI) activation message that maps a first codepoint to a first unified TCI state and a second codepoint to a second unified TCI state;
transmit a second TCI activation message that maps the first codepoint to a third unified TCI state and the second codepoint to a fourth unified TCI state;
transmit, during a TCI activation time for the second TCI activation message, a TCI indication message that indicates a codepoint identifier indication; and
transmit or receive a communication using a unified TCI state that corresponds to a codepoint of the second TCI activation message that matches the codepoint identifier indication, the unified TCI state being applied after an end of the TCI activation time for the second TCI activation message.

19. A user equipment (UE) for wireless communication, comprising:
a memory; and
one or more processors, coupled to the memory, configured to:
receive a first transmission configuration indicator (TCI) activation message that maps a first codepoint to a first unified TCI state and a second codepoint to a second unified TCI state;
receive a second TCI activation message that maps the first codepoint to a third unified TCI state and the second codepoint to a fourth unified TCI state;
receive a first TCI indication message that indicates a first codepoint identifier indication;
refrain from applying any unified TCI states indicated after the second TCI activation message and before an end of a TCI application time for the first TCI indication message; and
transmit or receive a communication using a unified TCI state of whichever of the first TCI activation message or the second TCI activation message has a codepoint that matches the first codepoint identifier indication.

20. (canceled)

21. A user equipment (UE) for wireless communication, comprising:
a memory; and
one or more processors, coupled to the memory, configured to:
receive a first transmission configuration indicator (TCI) activation message that maps a first codepoint to a first unified TCI state and a second codepoint to a second unified TCI state;
receive a second TCI activation message that maps the first codepoint to a third unified TCI state and the second codepoint to a fourth unified TCI state;
receive, during a TCI activation time for the second TCI activation message, a first TCI indication message that indicates a first codepoint identifier indication;
refrain from applying a matching unified TCI state of a matching codepoint of the second TCI activation message that matches the first codepoint identifier indication until after receiving a second TCI indication message that indicates a second codepoint identifier indication that is different than the first codepoint identifier indication; and
transmit or receive a communication using the matching unified TCI state, the matching unified TCI state being applied after receiving the second TCI indication message.

22. The UE of claim 21, wherein the one or more processors are further configured to apply a non-matching unified TCI state of a non-matching codepoint of the first TCI activation message that does not match the first codepoint identifier indication, the non-matching unified TCI state being applied at an end of the TCI activation time for the second TCI activation message

23-48. (canceled)
